(19) United States
(12) Patent Application Publication
(10) Pub. No.: US 2024/0152075 A1
(43) Pub. Date: May 9, 2024

(54) TONER CARTRIDGE

(71) Applicant: NINESTAR CORPORATION, Zhuhai (CN)

(72) Inventors: Xinyu WU, Zhuhai (CN); Likun ZENG, Zhuhai (CN); Qijie LIANG, Zhuhai (CN); Wenjun YU, Zhuhai (CN); Mengyuan LIU, Zhuhai (CN)

(21) Appl. No.: 18/413,908

(22) Filed: Jan. 16, 2024

Related U.S. Application Data
(63) Continuation of application No. PCT/CN2022/106256, filed on Jul. 18, 2022.

(30) Foreign Application Priority Data
Jul. 19, 2021 (CN) 202121642735.6
Aug. 10, 2021 (CN) 202121867125.6

(51) Int. Cl. G03G 15/08

(52) U.S. Cl. CPC G03G 15/0872; G03G 15/0886

(57) ABSTRACT

The present disclosure provides a toner cartridge, detachably installed in an electronic image-forming apparatus. The electronic image-forming apparatus includes a developer replenishing apparatus; the developer replenishing apparatus includes a developer receiving portion; the developer receiving portion includes a receiving opening; and the receiving opening is disposed with a blocking piece for sealing the receiving opening. The toner cartridge includes a toner cartridge body configured to store developer; and a toner outlet structure connected to a toner outlet end of the toner cartridge body and configured to discharge the developer in the toner cartridge body. The toner outlet structure further includes a control mechanism, configured to act on the developer receiving portion or the blocking piece during an installation process of the toner cartridge to cause relative movement between the control mechanism and one of the developer receiving portion and the blocking piece, thereby opening the receiving opening.

### CROSS-REFERENCE TO RELATED APPLICATION

This application is a continuation application of PCT Patent Application No. PCT/CN2022/106256, filed on Jul. 18, 2022, which claims the priority to Chinese patent application No. 202121642735.6, filed on Jul. 19, 2021, and No. 202121867125.6, filed on Aug. 10, 2021, the entirety of all of which is incorporated herein by reference.

### TECHNICAL FIELD

The present disclosure generally relates to the field of image-forming technology and, more particularly, relates to a toner cartridge.

### BACKGROUND

Electronic image-forming apparatuses are devices that form images on recording materials through electrophotographic image-forming processing technology such as electrophotographic copiers, laser printers, electrophotographic printers, fax machines, word processors and the like. A toner cartridge for supplying developer (e.g., carbon toner) can be detachably installed inside the electronic image-forming apparatus. As the developer continues to be used in electronic image-forming process, when the developer in the toner cartridge is exhausted, a user needs to replace the toner cartridge or inject new developer into the toner cartridge in time, which makes the toner cartridge a consumable part that is frequently replaced in electronic image-forming process.

In the existing technology, the toner cartridge is installed and uninstalled in a developer replenishing apparatus for receiving developer in the electronic image-forming apparatus. In addition, every installation and uninstallation operation of the toner cartridge in the developer replenishing apparatus involves the connection and disconnection of the toner outlet opening of the toner cartridge and the toner receiving opening of the developer replenishing apparatus.

FIG. 1 illustrates an exploded view of the toner cartridge detachably installed on the developer replenishing apparatus provided in the existing technology. A toner cartridge 1 may include a toner cartridge body 2 for accommodating developer, a toner outlet structure 3 located at a first end 21 along the length direction of the toner cartridge body 2, a sliding plate 4 which slides relative to the toner outlet structure 3. The toner outlet structure 3 may include an upper flange portion 3a, and a lower flange portion 3b; and the toner outlet structure 3 may also include structures such as a stirring frame, a toner mixing portion a toner outlet opening and the like for discharging the carbon toner in the toner cartridge body 2. Different structures can be designed according to different discharge principles. Referring to FIGS. 2A-2C, FIG. 2A illustrates a structural schematic of a developer replenishing apparatus; FIG. 2B illustrates a partially enlarged cross-sectional view of the developer replenishing apparatus; and FIG. 2C illustrates a three-dimensional schematic of a developer receiving portion. A developer replenishing apparatus 8 may at least include a developer receiving portion 11, a first sliding-plate locking portion 8a and a second sliding-plate locking portion 8b; and the developer receiving portion 11 may include a receiving opening 11a, an engaging portion 11b for opening and closing the receiving opening 11a and a sealing part 13. A blocking piece 15 located in the receiving opening 11a may be configured to seal the receiving opening 11a. The engaging portion 11b may drive rising and falling of the developer receiving portion 11, such that the receiving opening 11a and the blocking piece 15 may be in a separated state and a contact state, thereby opening and closing the receiving opening 11a. In addition, an elastic part 12 may also be disposed, such that the engaging portion 11b may move upward against the elastic force of the elastic part 12 and move downward under the action of the elastic force of the elastic part 12. In FIGS. 3A-3C, the guiding rail structure on the lower flange portion 3b of the toner outlet structure 3 is shown. Moreover, the guiding rail structure may be configured to lift the engaging portion 11b in the developer replenishing apparatus to open the receiving opening 11a of the developer replenishing apparatus. The guiding rail structure may include a raised first portion 3b2 and a second portion 3b4. As the toner cartridge 1 is installed along the direction of an arrow A, the engaging portion 11b may be guided by the first portion 3b2 to move upward to make the receiving opening 11a to be open and continue to move on the second portion 3b4 to the position where a toner outlet opening (not shown) in the toner cartridge is fully opened, such that the toner outlet opening in the toner cartridge and the receiving opening 11a may form a continuous developer discharge channel. During uninstallation process of the toner cartridge, similarly, when the toner cartridge 1 moves along a direction B opposite to the installation direction A, the toner outlet opening and the receiving opening 11a in the toner cartridge may be closed respectively. However, during the movement process of the engaging portion 11b guided by the second part 3b4 of the guiding rail, the receiving opening 11a may have been fully opened and moved upward to a sufficient height and may successively attach corresponding portions of the toner outlet structure 3 and the bottom of the sliding plate 4 and continue to move along the A/B direction with the installation or uninstallation of the toner cartridge. Even if sealing and position alignment are achieved, relative movement may inevitably occur. Since the developer includes extremely light particles, it is easy to cause the developer to be scattered to air due to elastic deformation of each sealing part when the relative movement occurs due to friction and vibration.

### SUMMARY

One aspect of the present disclosure provides a toner cartridge, detachably installed in an electronic image-forming apparatus, where the electronic image-forming apparatus includes a developer replenishing apparatus; the developer replenishing apparatus includes a developer receiving portion; the developer receiving portion includes a receiving opening; and the receiving opening is disposed with a blocking piece for sealing the receiving opening. The toner cartridge includes a toner cartridge body, configured to store developer; and a toner outlet structure, where the toner outlet structure is connected to a toner outlet end of the toner cartridge body and configured to discharge the developer in the toner cartridge body; the toner outlet structure includes a connecting part, a fixed toner outlet plate and a movable toner outlet plate; the connecting part is connected to the toner cartridge body; a toner outlet opening is formed at the connecting part; the fixed toner outlet plate is connected to a bottom of the connecting part and includes an opening; and the movable toner outlet plate is disposed between the connecting part and the fixed toner outlet plate and includes a toner outlet hole. The toner outlet structure further includes a control mechanism, configured to act on the developer receiving portion or the blocking piece during an installation process of the toner cartridge to cause relative movement between the control mechanism and one of the developer receiving portion and the blocking piece, thereby opening the receiving opening.

Another aspect of the present disclosure provides a toner cartridge, detachably installed in an electronic image-forming apparatus, where the electronic image-forming apparatus includes a developer replenishing apparatus; the developer replenishing apparatus includes a developer receiving portion; the developer receiving portion includes an engaging portion and a receiving opening. The toner cartridge includes a toner cartridge body, configured to store developer; and a toner outlet structure, where the toner outlet structure is connected to a toner outlet end of the toner cartridge body and configured to discharge the developer in the toner cartridge body; the toner outlet structure includes a connecting part, a fixed toner outlet plate and a movable toner outlet plate; the connecting part is connected to the toner cartridge body; a toner outlet opening is formed at the connecting part; the fixed toner outlet plate is connected to a bottom of the connecting part and includes an opening; and the movable toner outlet plate is disposed between the connecting part and the fixed toner outlet plate and includes a toner outlet hole. The toner outlet structure includes a guiding portion capable of partially moving up and down; and during an installation process of the toner cartridge, the guiding portion moves upward to drive the engaging portion to move, thereby opening the receiving opening.

Other aspects of the present disclosure may be understood by those skilled in the art in light of the description, the claims, and the drawings of the present disclosure.

### BRIEF DESCRIPTION OF THE DRAWINGS

FIG. 1 illustrates an exploded view of a toner cartridge of the existing technology.

FIG. 2A illustrates a structural schematic of a developer replenishing apparatus.

FIG. 2B illustrates a partially enlarged cross-sectional view of a developer replenishing apparatus.

FIG. 2C illustrates a three-dimensional schematic of a developer receiving portion.

FIG. 3A illustrates a schematic of a guiding rail structure of a toner cartridge of the existing technology.

FIG. 3B illustrates another schematic of a guiding rail structure of a toner cartridge of the existing technology.

FIG. 3C illustrates another schematic of a guiding rail structure of a toner cartridge of the existing technology.

FIG. 4 illustrates a structural schematic of a toner cartridge provided by exemplary embodiment one of the present disclosure.

FIG. 5 illustrates a structural schematic of a toner outlet structure of a toner cartridge provided by exemplary embodiment one of the present disclosure.

FIG. 6 illustrates another structural schematic of a toner outlet structure of a toner cartridge provided by exemplary embodiment one of the present disclosure.

FIG. 7 illustrates another structural schematic of a toner outlet structure of a toner cartridge provided by exemplary embodiment one of the present disclosure.

FIG. 8A illustrates a schematic of a toner cartridge at a first position of a receiving opening to-be-opened provided by exemplary embodiment one of the present disclosure.

FIG. 8B illustrates a schematic of a toner cartridge at a second position forming a discharge channel and opening a receiving opening provided by exemplary embodiment one of the present disclosure.

FIG. 9 illustrates a schematic of a toner outlet structure provided by exemplary embodiment two of the present disclosure.

FIG. 10A illustrates a schematic of a toner cartridge at a first position of a receiving opening to-be-opened provided by exemplary embodiment two of the present disclosure.

FIG. 10B illustrates a schematic of a toner cartridge at a second position forming a discharge channel and opening a receiving opening provided by exemplary embodiment two of the present disclosure.

FIG. 11 illustrates a schematic of a modified structure of a holding portion provided by exemplary embodiment two of the present disclosure.

FIG. 12 illustrates another schematic of a modified structure of a holding portion provided by exemplary embodiment two of the present disclosure.

FIG. 13 illustrates another schematic of a modified structure of a holding portion provided by exemplary embodiment two of the present disclosure.

FIG. 14 illustrates a schematic of a toner outlet structure provided by exemplary embodiment three of the present disclosure.

FIG. 15 illustrates an exploded view of a toner outlet structure provided by exemplary embodiment three of the present disclosure.

FIG. 16 illustrates a partially enlarged view of a fixed toner outlet plate provided by exemplary embodiment three of the present disclosure.

FIG. 17 illustrates a schematic of a surface of a guiding portion away from a side of a fixed toner outlet plate provided by exemplary embodiment three of the present disclosure.

FIG. 18 illustrates a schematic of a surface of a guiding portion adjacent to a side of a fixed toner outlet plate provided by exemplary embodiment three of the present disclosure.

FIG. 19 illustrates a three-dimensional schematic of a guiding portion provided by exemplary embodiment three of the present disclosure.

FIGS. 20-21 illustrate three-dimensional schematics of a locking part from different viewing angles provided by exemplary embodiment three of the present disclosure.

FIG. 22 illustrates a schematic of a toner outlet structure before a toner cartridge is installed into an electronic image-forming apparatus provided by exemplary embodiment three of the present disclosure.

FIG. 23 illustrates a schematic diagram of an internal structure after the guiding portion in FIG. 22 is removed.

FIG. 24 illustrates a schematic of a toner outlet structure when a toner cartridge is installed in place in an electronic image-forming apparatus provided by exemplary embodiment three of the present disclosure.

FIG. 25 illustrates a schematic of an internal structure of a guiding portion in FIG. 24.

FIG. 26A illustrates a structural side view of a toner outlet structure provided by exemplary embodiment four of the present disclosure.

FIG. 26B illustrates another structural side view of a toner outlet structure provided by exemplary embodiment four of the present disclosure.

FIG. 26C illustrates another structural side view of a toner outlet structure provided by exemplary embodiment four of the present disclosure.

FIG. 27A illustrates a structural side view of a toner outlet structure provided by exemplary embodiment five of the present disclosure.

FIG. 27B illustrates another structural side view of a toner outlet structure provided by exemplary embodiment five of the present disclosure.

FIG. 28A illustrates a structural side view of a toner outlet structure provided by exemplary embodiment five of the present disclosure.

FIG. 28B illustrates another structural side view of a toner outlet structure provided by exemplary embodiment five of the present disclosure.

FIG. 29A illustrates a structural side view of a toner outlet structure provided by exemplary embodiment six of the present disclosure.

FIG. 29B illustrates another structural side view of a toner outlet structure provided by exemplary embodiment six of the present disclosure.

FIG. 29C illustrates another structural side view of a toner outlet structure provided by exemplary embodiment six of the present disclosure.

FIG. 30 illustrates a structural schematic of a toner outlet structure provided by exemplary embodiment six of the present disclosure.

FIG. 31 illustrates a structural schematic of a toner outlet structure provided by exemplary embodiment seven of the present disclosure.

FIG. 32 illustrates another structural schematic of a toner outlet structure provided by exemplary embodiment seven of the present disclosure.

FIG. 33 illustrates a structural side view of a toner outlet structure provided by exemplary embodiment eight of the present disclosure.

FIG. 34A illustrates a structural side view of a toner outlet structure provided by exemplary embodiment nine of the present disclosure.

FIG. 34B illustrates another structural side view of a toner outlet structure provided by exemplary embodiment nine of the present disclosure.

FIG. 35 illustrates a structural schematic of a toner outlet structure provided by exemplary embodiment ten of the present disclosure.

FIG. 36 illustrates a structural side view of a toner outlet structure provided by exemplary embodiment ten of the present disclosure.

FIG. 37 illustrates another structural schematic of a toner outlet structure provided by exemplary embodiment ten of the present disclosure.

FIG. 38 illustrates another structural side view of a toner outlet structure provided by exemplary embodiment ten of the present disclosure.

FIG. 39 illustrates a structural schematic of a guiding portion provided by exemplary embodiment ten of the present disclosure.

FIG. 40 illustrates a structural schematic of a toner outlet structure provided by exemplary embodiment eleven of the present disclosure.

FIG. 41 illustrates a structural side view of a toner outlet structure provided by exemplary embodiment eleven of the present disclosure.

FIG. 42 illustrates another structural side view of a toner outlet structure provided by exemplary embodiment eleven of the present disclosure.

FIG. 43 illustrates a partial structural schematic of a toner outlet structure provided by exemplary embodiment twelve of the present disclosure.

FIG. 44 illustrates a structural schematic of a guiding portion provided by exemplary embodiment twelve of the present disclosure.

FIG. 45 illustrates a schematic of a structure and an action of a guiding portion provided by exemplary embodiment thirteen of the present disclosure.

FIG. 46 illustrates another schematic of a structure and an action of a guiding portion provided by exemplary embodiment thirteen of the present disclosure.

FIG. 47 illustrates a schematic of an action of a guiding portion driving an engaging portion to move upward provided by exemplary embodiment thirteen of the present disclosure.

FIGS. 48-51 illustrate schematics of actions when an abutting portion of a guiding portion and an abutting portion of a movable toner outlet plate are abutted with each other provided by exemplary embodiment thirteen of the present disclosure.

FIGS. 52-55 illustrate schematics of actions when a guiding portion and a pushed portion are abutted and cooperated with each other provided by exemplary embodiment thirteen of the present disclosure.

FIG. 56 illustrates a schematic of a toner outlet structure provided by exemplary embodiment fourteen of the present disclosure.

FIG. 57 illustrates another schematic of a toner outlet structure provided by exemplary embodiment fourteen of the present disclosure.

FIG. 58 illustrates another schematic of a toner outlet structure provided by exemplary embodiment fourteen of the present disclosure.

FIG. 59 illustrates another schematic of a toner outlet structure provided by exemplary embodiment fourteen of the present disclosure.

FIG. 60 illustrates a schematic of a toner outlet structure provided by solution one in exemplary embodiment fifteen of the present disclosure.

FIG. 61 illustrates a schematic of an engaging portion at a first end portion of a guiding portion provided by solution one in exemplary embodiment fifteen of the present disclosure.

FIG. 62 illustrates a schematic of an engaging portion at a second end portion of a guiding portion provided by solution one in exemplary embodiment fifteen of the present disclosure.

FIG. 63 illustrates a schematic of a control mechanism provided by solution one in exemplary embodiment fifteen of the present disclosure.

FIG. 64 illustrates an exploded view of a control mechanism provided by solution one in exemplary embodiment fifteen of the present disclosure.

FIG. 65 illustrates a partial enlarged view of FIG. 64.

FIG. 66 illustrates a schematic of a toner outlet structure provided by solution two in exemplary embodiment fifteen of the present disclosure.

FIG. 67 illustrates a schematic of a control mechanism provided by solution two in exemplary embodiment fifteen of the present disclosure.

FIG. 68 illustrates a partial enlarged view of FIG. 67.

FIG. 69 illustrates a schematic of a movable block provided by solution two in exemplary embodiment fifteen of the present disclosure.

FIG. 70 illustrates a schematic of a connecting part provided by solution two in exemplary embodiment fifteen of the present disclosure.

FIG. 71 illustrates a three-dimensional structural schematic of a toner cartridge provided by exemplary embodiment sixteen of the present disclosure.

FIG. 72 illustrates a partial enlarged view of a housing in FIG. 71.

FIGS. 73A-73C illustrate partial views of an installation process of a toner cartridge provided by exemplary embodiment sixteen of the present disclosure.

FIG. 74 illustrates a partial schematic of a toner outlet structure provided by exemplary embodiment sixteen of the present disclosure.

FIG. 75A illustrates a partial view of an installation process of a toner cartridge provided by exemplary embodiment sixteen of the present disclosure.

FIG. 75B illustrates another partial view of an installation process of a toner cartridge provided by exemplary embodiment sixteen of the present disclosure.

FIG. 76 illustrates a three-dimensional schematic of a toner outlet structure provided by exemplary embodiment seventeen of the present disclosure.

FIG. 77 illustrates a schematic of a control mechanism of a toner outlet structure provided by exemplary embodiment seventeen of the present disclosure.

FIG. 78 illustrates a schematic of a toner outlet structure observed from a bottom viewing angle provided by exemplary embodiment seventeen of the present disclosure.

FIG. 79 illustrates a schematic of a control mechanism at an initial position provided by exemplary embodiment seventeen of the present disclosure.

FIG. 80 illustrates a schematic of a control mechanism at a second position provided by exemplary embodiment seventeen of the present disclosure.

FIG. 81 illustrates a schematic of a positional relationship between a toner outlet opening and a toner outlet hole when a control mechanism is at a second position provided by exemplary embodiment seventeen of the present disclosure.

FIG. 82 illustrates a three-dimensional schematic of a toner outlet structure provided by exemplary embodiment eighteen of the present disclosure.

FIG. 83 illustrates a three-dimensional schematic of a toner outlet part of a toner outlet structure provided by exemplary embodiment eighteen of the present disclosure.

FIG. 84 illustrates a three-dimensional schematic of a movable toner outlet plate of a toner outlet structure provided by exemplary embodiment eighteen of the present disclosure.

FIG. 85 illustrates a schematic of a control mechanism of a toner outlet structure provided by exemplary embodiment eighteen of the present disclosure.

FIG. 86 illustrates a schematic of a toner outlet structure observed from a bottom viewing angle provided by exemplary embodiment eighteen of the present disclosure.

FIG. 87 illustrates a schematic of a control mechanism at an initial position provided by exemplary embodiment eighteen of the present disclosure.

FIG. 88 illustrates a schematic of a control mechanism at a second position provided by exemplary embodiment eighteen of the present disclosure.

FIG. 89 illustrates a schematic of a positional relationship between a toner outlet opening and a toner outlet part when a control mechanism is at a second position provided by exemplary embodiment eighteen of the present disclosure.

FIG. 90 illustrates a three-dimensional schematic of a toner outlet structure provided by exemplary embodiment nineteen of the present disclosure.

FIG. 91 illustrates a schematic of a toner outlet structure observed from a bottom viewing angle provided by exemplary embodiment nineteen of the present disclosure.

FIG. 92 illustrates a schematic of a control mechanism of a toner outlet structure provided by exemplary embodiment nineteen of the present disclosure.

FIG. 93 illustrates a schematic of a control mechanism at an initial position provided by exemplary embodiment nineteen of the present disclosure.

FIG. 94 illustrates a schematic of a control mechanism at a second position provided by exemplary embodiment nineteen of the present disclosure.

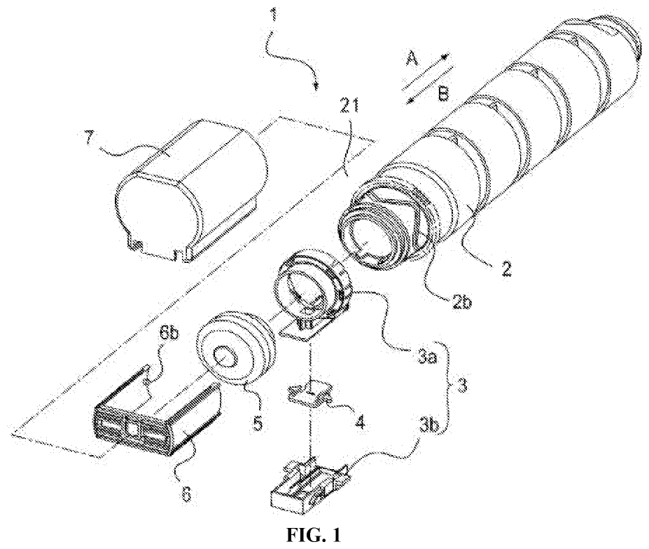

### DETAILED DESCRIPTION

The present disclosure is described in conjunction with accompanying drawings hereinafter.

Obviously, described embodiments are some of embodiments of the present disclosure, but not all embodiments. Based on the embodiments in the present disclosure, all other embodiments obtained by those skilled in the art without creative efforts fall within the protection scope of the present disclosure.

It should be noted that terms such as “first” and “second” are used for descriptive purposes only and should not be understood as indicating or implying relative importance or implicitly indicating the quantity of indicated technical features. Therefore, the features defined as “first” and “second” may explicitly or implicitly include at least one feature. In the specification of the present disclosure, “a plurality of” indicates at least two, such as two, three and the like, unless otherwise defined.

In the present disclosure, unless otherwise clearly specified and limited, the terms “installation”, “connection”, “fixation” and other terms should be understood in a broad sense. For example, above terms may indicate a fixed connection, a detachable connection or an integrated connection; a mechanical connection, an electrical connection or communication with each other; a direct connection, an indirect connection through an intermediate medium, an internal communication of two components or an interaction relationship between two components, unless otherwise specified limit. Those skilled in the art can understand specific meanings of above terms in the present disclosure according to specific situations.

In the present disclosure, unless otherwise clearly specified and limited, a first feature being “on” or “under” a second feature may indicate that the first and second features are in direct contact with each other, or the first and second features are in indirect contact through an intermediate medium. Moreover, the first feature is “above”, “on” and “on the top of” the second feature may indicate that the first feature is directly above or obliquely above the second feature, or simply indicate that the first feature is higher than the second feature horizontally. The first feature is “below”, “beneath” and “under” the second feature may indicate that the first feature is directly below or obliquely below the second feature, or simply indicates that the first feature is lower than the second feature horizontally.

In above description, descriptions referring to the terms “one embodiment”, “some embodiments”, “example”, “specific examples” or “some examples” indicate that particular features, structures, materials or characteristics described in connection with the embodiments or examples are included in at least one embodiment or example of the present disclosure. In the specification, schematic representations of above terms are not necessarily directed to same embodiments or examples. Furthermore, described specific features, structures, materials or characteristics may be combined in any suitable manner in any one or more embodiments or examples. In addition, those skilled in the art may combine different embodiments or examples and features of different embodiments or examples described in the specification without conflicting with each other.

### Exemplary Embodiment One

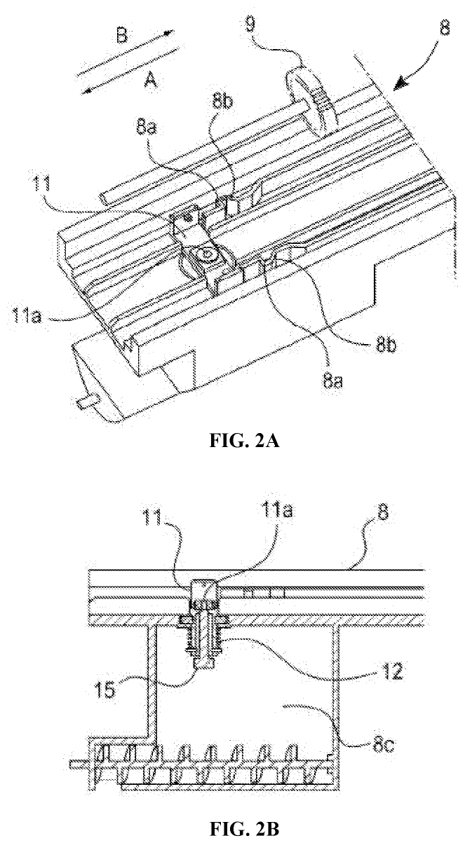

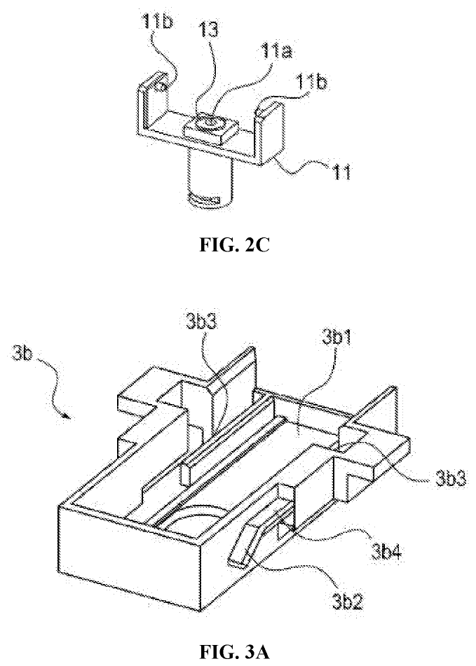

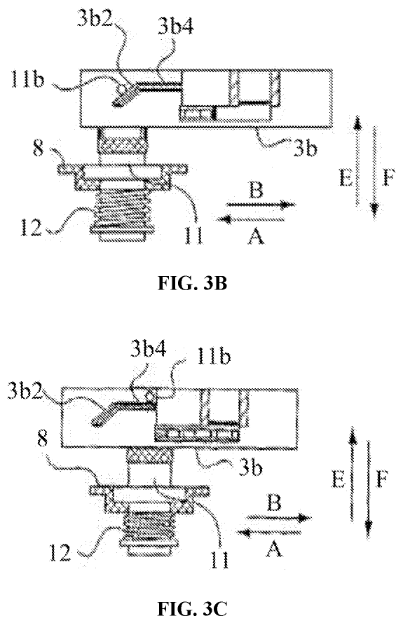

A toner cartridge, which is detachably installed in an electronic image-forming apparatus, is provide in one embodiment. The installation method of the toner cartridge of the present disclosure may be similar to the installation method in the existing technology. The toner cartridge may be also installed on the developer replenishing apparatus 8 in the electronic image-forming apparatus, as shown in FIGS. 2A-2C.

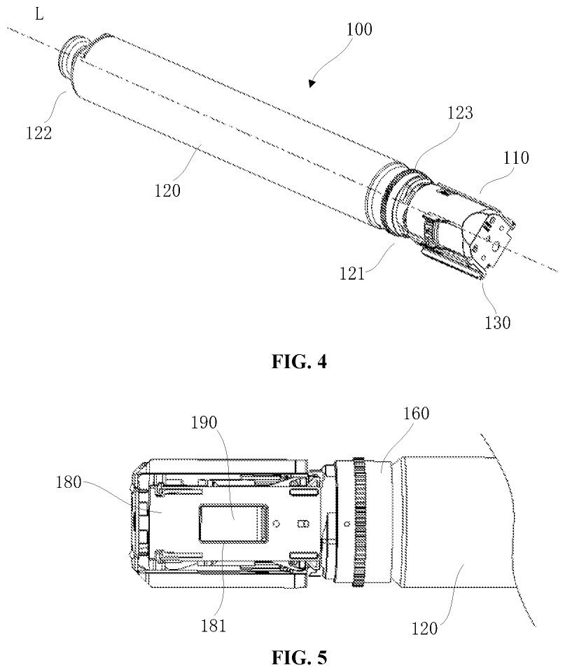

Referring to FIGS. 4-6, a toner cartridge 100 may include a housing 110, a toner cartridge body 120 and a toner outlet structure 130. The toner cartridge body 120 may be a long cylindrical structure in one embodiment. Along the extending length direction of the toner cartridge body 120, two ends of the toner cartridge body 120 may be respectively a first end 121 and a second end 122. The first end 121 may be a toner outlet end, and the inside of the toner cartridge body 120 may include an accommodating chamber for storing developer. When the toner cartridge 100 is installed in the electronic image-forming apparatus, the toner cartridge body 120 may be driven to rotate around its rotation axis L in the electronic image-forming apparatus. The toner outlet structure 130 may be connected to the first end 121 and configured for discharging the developer in the toner cartridge body 120 into the electronic image-forming apparatus to participate in development. The housing 110 may cover the toner outlet structure 130.

Furthermore, a ring gear 123 may be disposed on the toner cartridge body 120. The ring gear 123 may be engaged with the electronic image-forming apparatus to obtain a rotational driving force from the electronic image-forming apparatus, thereby driving the toner cartridge body 120 to rotate around the rotation axis L and relative to the toner outlet structure 130.

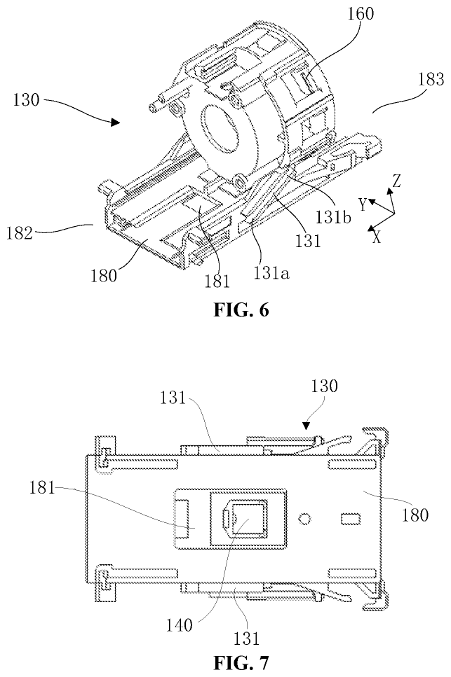

The toner outlet structure 130 may include a connecting part 160 and a fixed toner outlet plate 180. The connecting part 160 may be connected to the first end 121 of the toner cartridge body 120. The connecting part 160 may be provided with a toner outlet opening 140 (refer to FIG. 7). The fixed toner outlet plate 180 may be connected to the connecting part 160 and include an opening 181. Along the first direction (the Z direction in FIG. 6), the projection of the toner outlet opening 140 and the projection of the opening 181 may be at least partially overlapped with each other. In one embodiment, the projection of the toner outlet opening 140 along the first direction may completely fall within the projection of the opening 181 along the first direction. The internal mechanical structure of the toner outlet structure 130 may be a structure configured according to different toner feeding principles in the existing technology, which may not be described in detail herein.

In one embodiment, both the fixed toner outlet plate 180 and the toner outlet opening 140 may be located at the bottom of the toner outlet structure 130. For example, the toner outlet opening 140 may be formed at the bottom of the connecting part 160 and may be adjacent to the rotation axis L compared to the fixed toner outlet plate 180. The opening 181 may be formed at the bottom of the fixed toner outlet plate 180; and the shape and size of the opening 181 may be larger than that of the toner outlet opening 140. Along the first direction, the toner outlet opening 140 may be located above the opening 181, that is, the distance between the toner outlet opening 140 and the rotation axis L may be less than the distance between the opening 181 and the rotation axis L. In such way, the developer stored in the toner cartridge body 120 may be discharged to the outside of the toner cartridge 100 through the toner outlet opening 140 and the opening 181.

The toner outlet structure 130 may also include a movable toner outlet plate 190. The movable toner outlet plate 190 may be disposed between the connecting part 160 and the fixed toner outlet plate 180 along the first direction. A toner outlet hole (not shown) may be formed on the movable toner outlet plate 190. When the toner cartridge is installed into the developer replenishment unit in the electronic image-forming apparatus, the first sliding-plate locking portion 8a and the second sliding-plate locking portion 8b may lock the protrusions (not shown) on two sides of the movable toner outlet plate 190, such that the movable toner outlet plate 190 may be engaged with the developer replenishing apparatus 8 to be kept in a fixed state. The fixed toner outlet plate 180 may continue to be installed along with the toner cartridge 100 along the second direction (the X direction in FIG. 6), such that the movable toner outlet plate 190 and the fixed toner outlet plate 180 may move relatively. When the opening 181 on the fixed toner outlet plate 180 gradually coincides with the toner outlet opening 140 through the toner outlet hole on the movable toner outlet plate 190, a discharge channel may be formed. The developer stored inside the toner cartridge body 120 may be discharged to the outside of the toner cartridge 100 through the toner outlet opening 140, the toner outlet hole on the movable toner outlet plate 190, and the opening 181.

When the toner cartridge 100 is installed in the electronic image-forming apparatus, in order to guide the movement of the developer receiving portion 11 conveniently, the toner outlet structure 130 may also include a guiding portion 131. The engaging portion 11b of the developer receiving portion 11 in the developer replenishing apparatus 8 may be guided by the guiding portion 131 to open the receiving opening 11a with a simple structure and process. For example, as shown in FIG. 6, the fixed toner outlet plate 180 may include a first end body 182 away from the toner cartridge body 120 and a second end body 183 adjacent to the toner cartridge body 120. Along the direction of the rotation axis L, two sides of the fixed toner outlet plate 180 may be mirror-disposed with upward bent sidewalls, and the guiding portions 131 may be protruding structures respectively extending from the sidewalls on two sides of the fixed toner outlet plate 180.

For example, the guiding portion 131 may be connected to the sidewall of the fixed toner outlet plate 180 and disposed obliquely in a straight line or in a curved line along the direction from the first end body 182 to the second end body 183. In addition, the guiding portion 131 may include a first end portion 131a and a second end portion 131b; and the second end portion 131b may be closer to the rotation axis L than the first end portion 131a. That is, along the first direction, the second end portion 131b may be located above the first end portion 131a; and the second end portion 131b may be located above the toner outlet opening 140. In one embodiment, at the second end portion 131b, the inclination slope of the guiding portion 131 may be not 0; in other words, the guiding portion 131 near the second end portion 131b may be not in parallel with the axis L. When the toner cartridge is installed in the electronic image-forming apparatus, the developer receiving portion 11 may move from the first end portion 131a to the second end portion 131b along the guiding portion 131, such that the developer in the toner cartridge body 120 may flow into the electronic image-forming apparatus through the toner outlet opening 140 and the developer receiving portion 11.

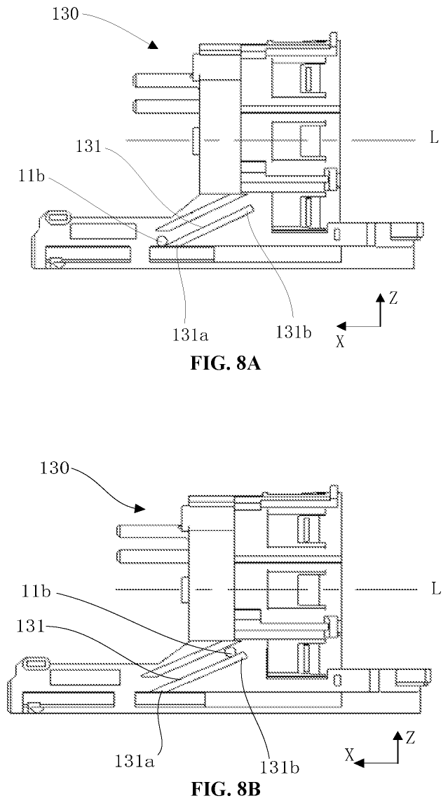

Referring to FIGS. 8A-8B, taking the installation operation of the toner cartridge 100 as an example, with the toner cartridge 100 installed on the developer replenishing apparatus 8 along the second direction (the X direction in FIG. 8A), the toner cartridge 100 may be located at the first position of the receiving opening 11a to-be-opened in FIG. 8A. The engaging portion 11b for opening and closing the receiving opening 11a may be located at the first end portion 131a of the guiding portion 131; and as the toner cartridge 100 moves further along the second direction, the guiding portion 131 may guide the engaging portion 11b to gradually climb to the second end portion 131b. At this point, the upward movement of the engaging portion 11b may gradually open the receiving opening 11a; as the first sliding-plate locking portion 8a and the second sliding-plate locking portion 8b mentioned above lock the movable toner outlet plate 190, the toner outlet hole, the toner outlet opening 140 and the opening 181 on the movable toner outlet plate 190 may gradually form the developer discharge channel; and finally the docking and alignment of the receiving opening 11a and the discharge channel may be completed at the second end portion 131b. At this point, the discharge channel may be located on a plane passing through the second end portion 131b and perpendicular to the rotation axis L, which may allow the developer in the toner cartridge body 120 to flow into the electronic image-forming apparatus. That is, in FIG. 8B, the toner cartridge 100 may be located at the second position where the discharge channel is formed and the receiving opening 11a is opened; and the developer in the toner cartridge 100 may flow smoothly into the developer replenishing apparatus 8 at the second end portion 131b. During previous moving process, the receiving opening 11a may be not fully opened. Therefore, under the action of the guiding portion 131, the receiving opening 11a may not be prematurely abutted against the fixed toner outlet plate 180 or the movable toner outlet plate 190 during the installation of the toner cartridge 100; and there may be no developer scattering caused by friction, vibration and the like during the installation and movement of the toner cartridge 100.

### Exemplary Embodiment Two

In one embodiment, on the basis of exemplary embodiment one, the toner outlet structure 130 may further include a holding portion 132.

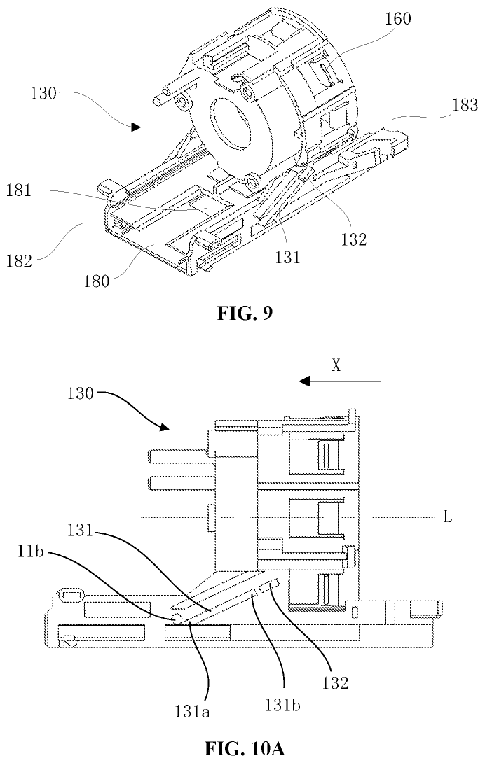

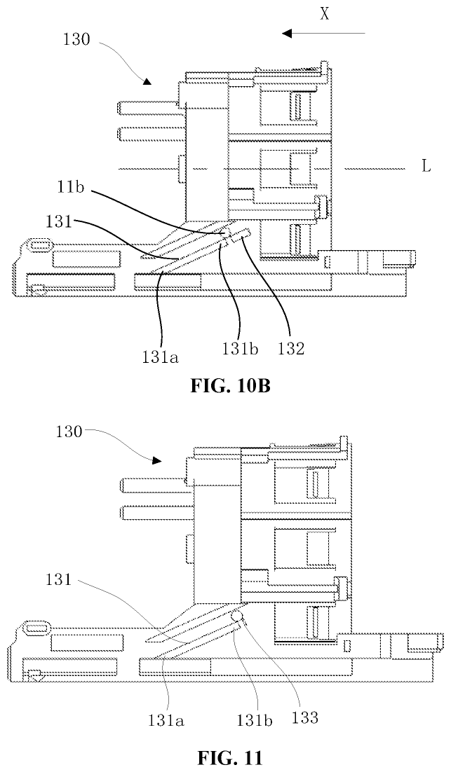

Referring to FIGS. 9-10B, FIG. 10A-10B respectively illustrate the toner cartridge at the first position where the receiving opening 11a is to-be-opened and at the second position where the discharge channel is formed and the receiving opening 11a is opened. The toner outlet structure 130 may also include the holding portion 132 which is configured to limit the engaging portion 11b when the toner cartridge is installed in the electronic image-forming apparatus. Optionally, a pair of holding portions 132 may be mirror-disposed on two sidewalls of the fixed toner outlet plate 180. The holding portion 132 may be a protrusion protruding from the sidewall of the fixed toner outlet plate 180 and may be disposed outside the guiding portion 131 or on the guiding portion 131. When the holding portion 132 is disposed outside the guiding portion 131, the holding portion 132 may be an independent part spaced apart from the second end portion 131b of the guiding portion 131 by a certain distance. That is, the holding portion 132 may be spaced apart from the second end portion 131b of the guiding portion 131, such that the engaging portion 11b moved to the second end portion 131b may be locked into a gap between the holding portion 132 and the guiding portion 131, as shown in FIG. 10B, thereby maintaining the open state of the receiving opening 11a.

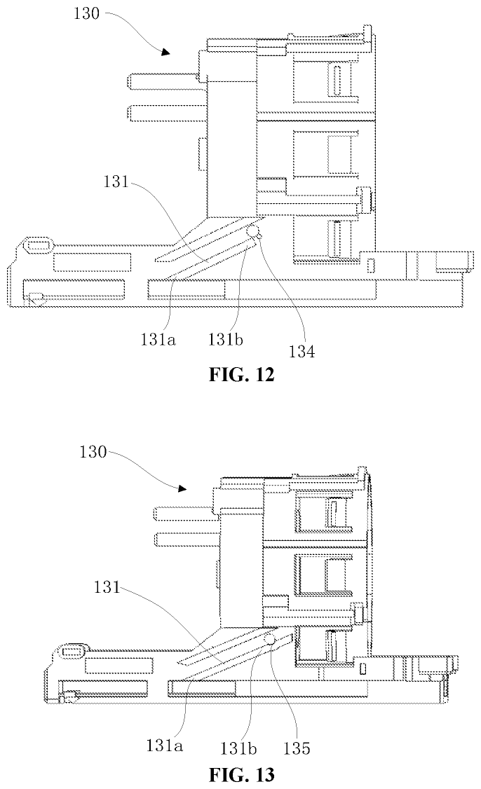

In addition, the holding portion 132 may be a modified structure, for example, a thin-sheet structure 133 as shown in FIG. 11, or a cylindrical structure 134 as shown in FIG. 12, or a structure that the cross section is a triangle, a cone or a regular or irregular polygon. When the toner cartridge is at the position where the discharge channel is formed and the receiving opening 11a is opened, the engaging portion 11b may be held at the position where the receiving opening 11a is opened through using the gap between the holding portion 132 and the guiding portion 131. In addition, when the holding portion 132 is disposed on the guiding portion 131, the holding portion 132 may also be a surface with a high friction coefficient located at the second end portion 131b, or a groove 135 as shown in FIG. 13 which may directly utilize the frictional force or the groove locking to hold the engaging portion 11b on the holding portion 132, thereby keeping the position of opening the receiving opening 11a.

Optionally, a chamfered structure may also be disposed on the second end portion 131b of the guiding portion 131 and a contact portion of the holding portion 132 that engages with the engaging portion 11b (that is, a portion at a position that the holding portion 132 and the guiding portion 131 are spaced apart), such that the toner cartridge 100 may be easily to disengage from the locking structure during uninstallation.

### Exemplary Embodiment Three

A new toner cartridge solution is provided in one embodiment. In one embodiment, parts that are not clearly indicated may be same as the parts in the existing technology and exemplary embodiment one. The structure of the engaging portion 11b configured to guide the electronic image-forming apparatus is described in one embodiment.

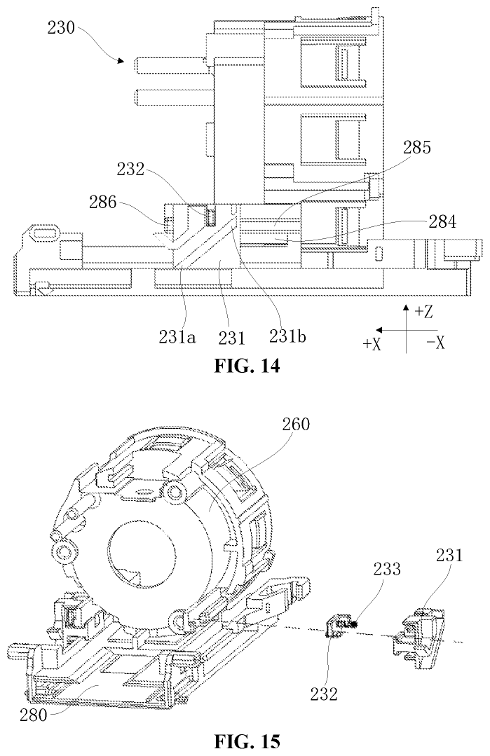

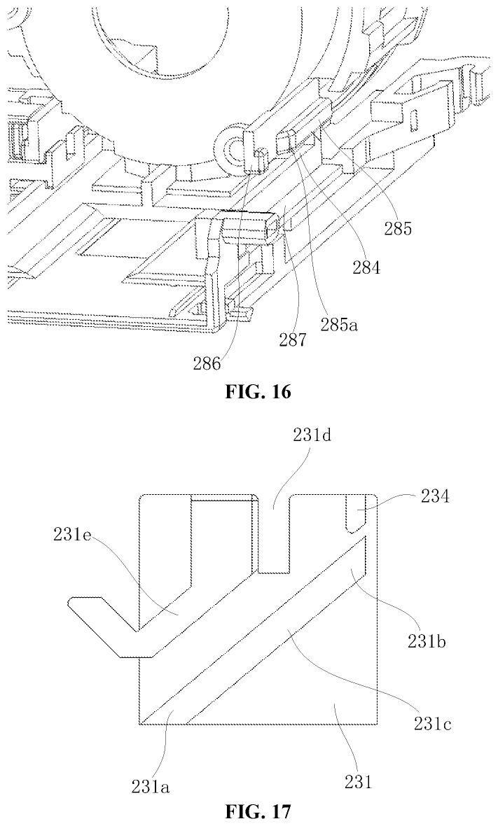

Referring to FIGS. 14-16, FIG. 14 illustrates a schematic of a toner outlet structure provided by exemplary embodiment three of the present disclosure; FIG. 15 illustrates an exploded view of the toner outlet structure provided by exemplary embodiment three of the present disclosure; and FIG. 16 illustrates a partially enlarged view of a fixed toner outlet plate provided by exemplary embodiment three of the present disclosure. A toner outlet structure 230 may include a connecting portion 260, a fixed toner outlet plate 280 and a guiding portion 231 (e.g., a guiding part). The connecting portion 260 may be connected to the first end of the toner cartridge body 120, the fixed toner outlet plate 280 may be connected to the connecting portion 260, and the guiding portion 231 may be movably disposed on the sidewall of the fixed toner outlet plate 280.

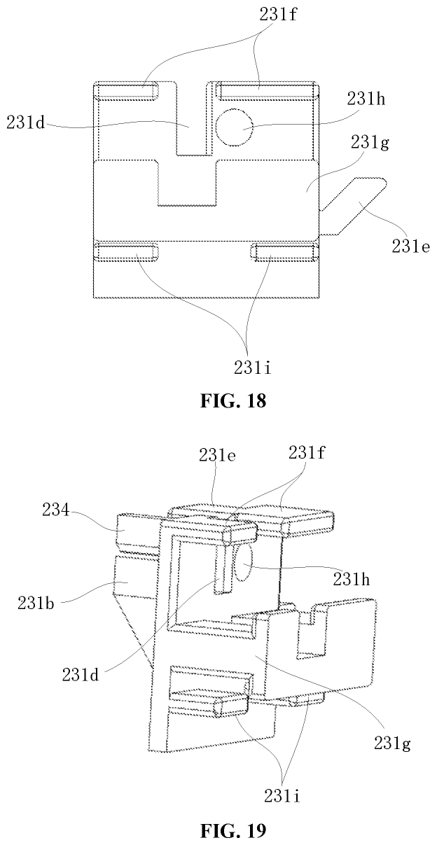

Referring to FIGS. 17-19, FIG. 17 illustrates a schematic of a surface of the guiding portion away from a side of the fixed toner outlet plate provided by exemplary embodiment three of the present disclosure; FIG. 18 illustrates a schematic of a surface of the guiding portion adjacent to the side of the fixed toner outlet plate provided by exemplary embodiment three of the present disclosure; and FIG. 19 illustrates a three-dimensional schematic of the guiding portion provided by exemplary embodiment three of the present disclosure. As shown in FIGS. 14 and 17-19, the guiding portion 231 may include a guiding rail 231c having a first end portion 231a and a second end portion 231b. When the toner cartridge is installed, the engaging portion 11b of the electronic image-forming apparatus may move from the first end portion 231a to the second end portion 231b along the guiding rail 231c.

In one embodiment, the toner outlet structure 230 may also include a first force-receiving block 234. The first force-receiving block 234 may be connected to the guiding portion 231 and above the second end portion 231b. The first force-receiving block 234 may be configured to cooperate with the engaging portion 11b. During the process of installing the toner cartridge in the electronic image-forming apparatus along the second direction, the engaging portion 11b and the first force-receiving block 234 may be abutted against with each other and push whole guiding portion 231 to move along with the installation of the toner cartridge and the movement of the engaging portion 11b. That is, the guiding portion 231 may be pushed to move along the direction opposite to the second direction, that is, move from a direction away from the connecting portion 260 to a direction adjacent to the connecting portion 260 (the −X direction in FIG. 14).

Furthermore, the fixed toner outlet plate 280 may include a rail 284, an abutting block 285, an anti-disengaging block 286 and a balancing block 287. Optionally, a chamfer 285a may be disposed at the end of the abutting block 285 adjacent to the anti-disengaging block 286. The guiding portion 231 may also include an auxiliary guiding rail 231e. The auxiliary guiding rail 231e may be located on a same side as the guiding rail 231c of the guiding portion 231, and the auxiliary guiding rail 231e and the guiding rail 231c may cooperate with each other to assist the engaging portion 11b to move more smoothly on the guiding rail 231c of the guiding portion 231. The guiding portion 231 may further include a fitting part 231g, a first auxiliary block 231f and a second auxiliary block 231i. The fitting part 231g, the first auxiliary block 231f and the second auxiliary block 231i may be all disposed on the side of the guiding portion 231 facing away from the auxiliary guiding rail 231e and the guiding rail 231c. The fitting part 231g may be in the shape of a capital “I”, which may be configured to be installed in the rail 284. The first auxiliary block 231f may be configured to be installed on the upper part of the abutting block 285 along the vertical direction, and the second auxiliary block 231i may be configured to be installed above the balancing block 287. Through the joint action of the first auxiliary block 231f, the second auxiliary block 231i and the capital “I” shaped fitting part 231g, it ensures that the guiding portion 231 may move as smoothly as possible with reduced shaking.

The toner outlet structure 230 may also include a locking part 232 and an elastic part 233. The locking part 232 may be movably disposed on the guiding portion 231. The locking part 232 may have an unlocked position and a locked position on the guiding portion 231. During the process that the locking part 232 moves along with the guiding portion 231 in the opposite direction of the second direction (the X direction in FIG. 14), the locking part 232 may protrude from the guiding portion 231 to limit the engaging portion 11b. At this point, the locking part 232 may have reached the locked position. The elastic part 233 may be disposed between the locking part 232 and the guiding portion 231 and configured to act on the locking part 232. During the process that the locking part 232 moves along with the guiding portion 231 along the second direction, the elastic part 233 may act on the locking part 232 to make the locking part 232 to be retracted which may release the limit on the engaging portion 11b. At this point the locking part 232 may have reached the unlocked position. Furthermore, a gap 231d may be formed on the other side of the first force-receiving block 234 relative to the engaging portion 11b installed in place, such that the locking part 232 may pass through the gap 231d.

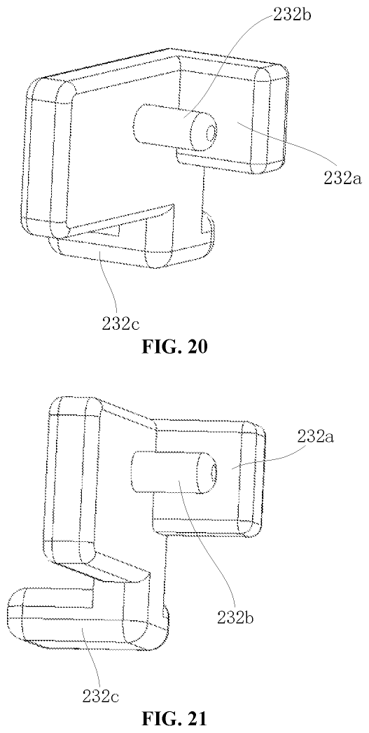

FIGS. 20 and 21 are three-dimensional schematics of the locking part from different viewing angles. The locking part 232 may include a stabilizing portion 232c and a second force-receiving block 232a. The second force-receiving block 232a may be connected to the stabilizing portion 232c. When the locking part 232 moves along with the guiding portion 231 in the direction opposite to the second direction, the stabilizing portion 232c may contact and interfere with the abutting block 285, such that the second force-receiving block 232a may protrude out from the gap 231d, thereby being in contact with the engaging portion 11b of the electronic image-forming apparatus to receive force.

Furthermore, a first fixing portion 231h for fixing one end of the elastic part 233 may be disposed on the back of the guiding portion 231. Optionally, the first fixing portion 231h may be a hole that does not pass through the guiding portion 231. The locking part 232 may also include a second fixing portion 232b for fixing the other end of the elastic part 233. Optionally, the second fixing portion 232b may be a protruding column connected to the stabilizing portion 232c, and the elastic part 233 may be a compression spring. During installation, one end of the elastic part 233 may be sleeved on the second fixing portion 232b, and the other end of the elastic part 233 may be located at the first fixing portion 231h, thereby limiting the elastic part 233. That is, the elastic part 233 may be disposed between the stabilizing portion 232c and the guiding portion 231.

In order to prevent the locking part 232 from shifting when moving along the second direction with the guiding portion 231, the stabilizing portion 232c may be inserted into the groove of the capital “I” shaped fitting part 231g, thereby ensuring that relative movement of the locking part 232 and the guiding portion 231 should be avoided as possible.

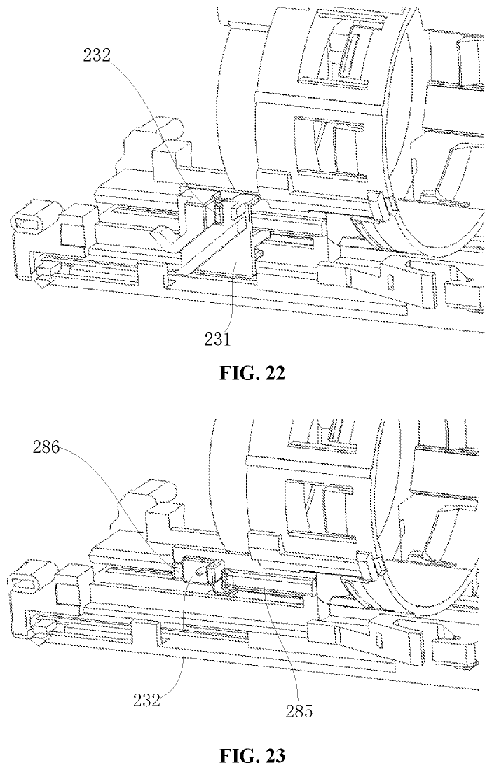

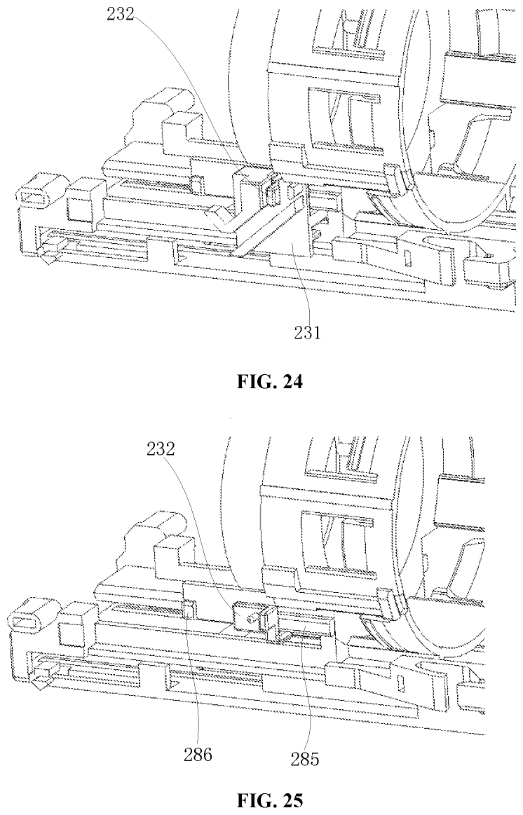

FIG. 22 illustrates a schematic of the toner outlet structure before the toner cartridge is installed into the electronic image-forming apparatus provided by exemplary embodiment three of the present disclosure; FIG. 23 illustrates a schematic of an internal structure after the guiding portion in FIG. 22 is removed; FIG. 24 illustrates a schematic of the toner outlet structure when the toner cartridge is installed in place in the electronic image-forming apparatus provided by exemplary embodiment three of the present disclosure; and FIG. 25 illustrates a schematic of an internal structure of a guiding portion in FIG. 24. Referring to FIGS. 22-23, before the toner cartridge is installed in the electronic image-forming apparatus, the locking part 232 may be located between the anti-disengaging block 286 and the abutting block 285, and the locking part 232 may not protrude out relative to the guiding portion 231. During the installation process, the engaging portion 11b of the electronic image-forming apparatus may move from the first end portion 231a to the second end portion 231b of the guiding portion 231. Next, the engaging portion 11b may be abutted against the first force-receiving block 231c and drive the whole guiding portion 231 and the locking part 232 to move along the rail 284. Due to the contact interference between the locking part 232 and the abutting block 285, the second force-receiving part 232a may gradually protrude out from the gap 231d, and the elastic part 233 may be at a compressed state. When the toner cartridge is completely installed and the engaging portion 11b moves to the installation position configured by the electronic image-forming apparatus, the state shown in FIGS. 24-25 may be reached. At this point, similar to exemplary embodiment one, the discharge channel may be formed on a plane passing through the second end portion 231b of the guiding rail and perpendicular to the rotation axis, which may allow the developer in the toner cartridge to flow into the electronic image-forming apparatus; and the toner cartridge may operate normally. When the toner cartridge needs to be uninstalled after completing operations, the engaging portion 11b may be abutted against the second force-receiving block 232a, move along the rail 284 in the direction opposite to the second direction (installation direction) and drive the guiding portion 231 and the locking part 232 to move together. Until moving to the position shown in FIGS. 22-23, the locking part 232 may no longer contact and interfere with the abutting block 285; and due to the release of elastic potential energy, the elastic part 233 may push the second force-receiving block 232a to retract from the gap 231d which may be no longer in contact with the engaging portion 11b. Next, the engaging portion 11b may moves from the second end portion 231b to the first end portion 231a along the guiding portion 231, thereby completing the disengagement of the engaging portion 11b during the process of uninstalling the toner cartridge.

### Exemplary Embodiment Four

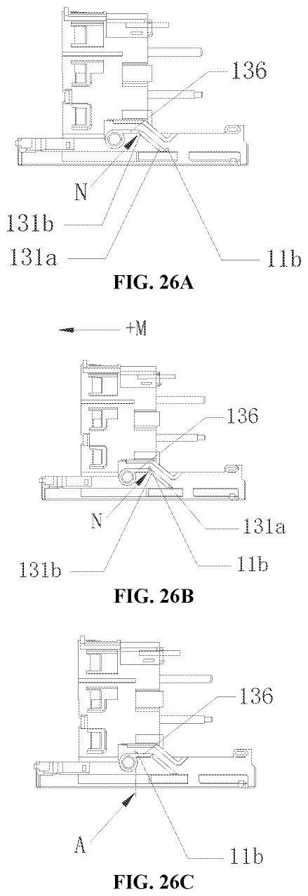

Referring to FIGS. 26A-26C, in one embodiment, on the basis of exemplary embodiment two, the holding portion may be configured as a planar structure. For example, a holding portion 136 may be disposed on the sidewall of the fixed toner outlet plate 180, and the holding portion 136 may extend along the second direction (installation direction). The second direction may be in parallel with the extending direction of the rotation axis of the toner cartridge, such that the distance between the holding portion 136 and the rotation axis of the toner cartridge may not change. For example, the holding portion 136 may be also disposed outside the guiding portion 131. The holding portion 136 may be an independent part spaced from the second end portion 131b of the guiding portion 131by a certain distance. That is, the holding portion 136 may be spaced apart from the second end portion 131b of the guiding portion 131. Different from exemplary embodiment two, the inclination slope of the guiding portion of 131 in one embodiment may be increased to a certain extent compared with exemplary embodiment two; and the size of the gap N between the holding portion 132 and the guiding portion 131 may be less than the maximum diameter of the engaging portion 11b (the maximum diameter of the cross-section of the cylinder when the engaging portion 11b is a cylinder). In such way, the engaging portion 11b may stay on the holding portion 136 after passing through the gap between the holding portion 136 and the second end portion 131b of the guiding portion 131 under the action of the insertion force of the toner cartridge installation. That is, compared with exemplary embodiment two, in one embodiment, the engaging portion 11b may be no longer locked between the holding portion 136 and the guiding portion 131 at the gap N after gradually rising from the first end portion 131a to the second end portion 131b of the guiding portion 131. At this point, the toner cartridge may have not been inserted to final position but continue to be inserted along the direction of the arrow +M (the installation direction which is opposite to the second direction) under the action of the insertion force of the toner cartridge installation (e.g., manually given force). Under the action of the insertion force, and the size of the gap N is less than the diameter of the engaging portion 11b, the engaging portion 11b may completely pass through the gap N and reach the holding portion 136. After the engaging portion 11b reaches the holding portion 136, as the toner cartridge is installed in place, the engaging portion 11b may be directly maintained on the holding portion 136, that is, the engaging portion 11b may not move relative to the holding portion 136; and may also be maintained on the holding portion 136 after moving a certain distance on the holding portion 136, thereby keeping the open state of the receiving opening 11a. These two manners may be adjusted according to the inclination slope of the guiding portion 131. When the engaging portion 11b is at final position on the holding portion 136, the toner outlet hole on the movable toner outlet plate 190 of the toner cartridge may be coincided with the toner outlet opening 140 to form the discharge channel. The center line A in FIG. 26C represents the center line of the discharge channel, and the carbon toner may be discharged from the toner cartridge at this position.

### Exemplary Embodiment Five

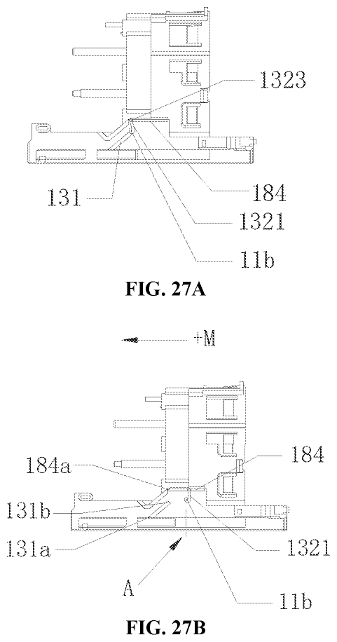

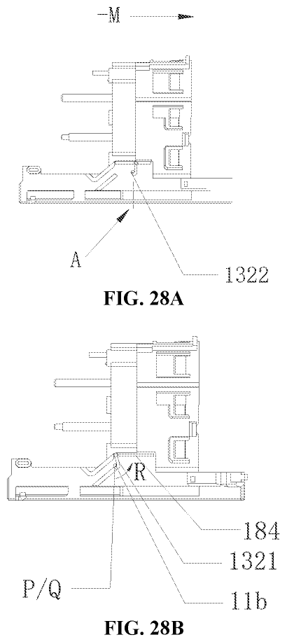

Referring to FIGS. 27A-28A, in one embodiment, the holding portion may be configured as a movable structure. The holding portion 1321 may be movably disposed on the sidewall of the fixed toner outlet plate 180, and the moving manner of the holding portion 1321 may be translation. For example, a guiding column 1323 may be disposed on the holding portion 1321, and a guiding groove 184 cooperated with the guiding column 1323 may be disposed on the sidewall of the fixed toner outlet plate 180, such that the holding portion 1321 may move along the guiding groove 184. The guiding groove 184 may be disposed by extending along the second direction; and the second direction may be in parallel with the extending direction of the rotation axis of the toner cartridge extends. The holding portion 1321 may move horizontally in the guiding groove, that is, there is no distance change relative to the rotation axis of the toner cartridge. During the process of installing the toner cartridge in the electronic image-forming apparatus, the engaging portion 11b may be held on the holding portion 1321 after climbing from the first end portion 131a to the second end portion 131b of the guiding portion 131, and the holding portion 1321 may carry the engaging portion 11b guided by the guiding portion 131 at the initial position (the position abutting against the outside of the second end portion 131b). With the insertion force of the toner cartridge installation along the +M direction, the engaging portion 11b and the holding portion 1321 carrying the engaging portion 11b may move in the guiding groove 184 along the second direction. Finally, as shown in FIG. 27B, when the engaging portion 11b is at the final position on the holding portion 1321, the toner outlet hole on the movable toner outlet plate 190 of the toner cartridge may be coincided with the toner outlet opening 140 to form the discharge channel. The center line A in FIG. 26C represents the center line of the discharge channel, and the carbon toner may be discharged from the toner cartridge at this position.

Furthermore, as shown in FIG. 28A, the holding portion 1321 may be also disposed with an abutting surface 1322. When the toner cartridge is moved along the arrow −M direction (opposite to the installation direction) to be uninstalled from the electronic image-forming apparatus, the engaging portion 11b and the holding portion 1321 carrying the engaging portion 11b may be also moved in the guiding groove 184. Finally, as shown in FIG. 28A, the abutting surface 1322 may be disposed on the holding portion 1321 to be in contact with the engaging portion 11b; and the holding portion 1321 may be driven to move along the +M direction relative to the guiding groove 184 by abutting between the abutting surface and the engaging portion.

When the toner cartridge continues to be uninstalled, the holding portion 1321 for carrying the engaging portion 11b may reach the second end portion 131b in the guiding groove 184. As shown in FIGS. 27B and 28B, one end portion 184a of the guiding groove 184 and the second end portion 131b of the guiding portion 131 may be further away from the toner outlet opening 140 along the direction in parallel with the rotation axis. Therefore, when the holding portion 1321 moves to one end portion 184a of the guiding groove 184, the holding portion may interfere with the second end portion 131b. Optionally, an outward inclined surface Q opposite to the abutting surface 1322 of the holding portion 1321 may be configured to be in contact with an inclined surface P of the second end portion 131b, and two inclined surfaces may move relative to each other for a certain extent. Under the guidance of the contact movement of two inclined surfaces, the holding portion 1321 may rotate on the toner cartridge using the guiding column 1323 on the holding portion 1321 as the rotation axis, where the direction of rotation is an arrow R, until the abutting surface 1322 is cooperated with the second end portion 131b to “send” the engaging portion 11b to the second end portion 131b without interference. Thereafter, the inclined surface Q of the holding portion 1321 may continue to be adjoined with the inclined surface P of the second end portion 131b, thereby maintaining the position of the holding portion 1321 after rotation and receiving the engaging portion 11b climbing up from the second end portion 131b without interference when the toner cartridge is installed next time.

### Exemplary Embodiment Six

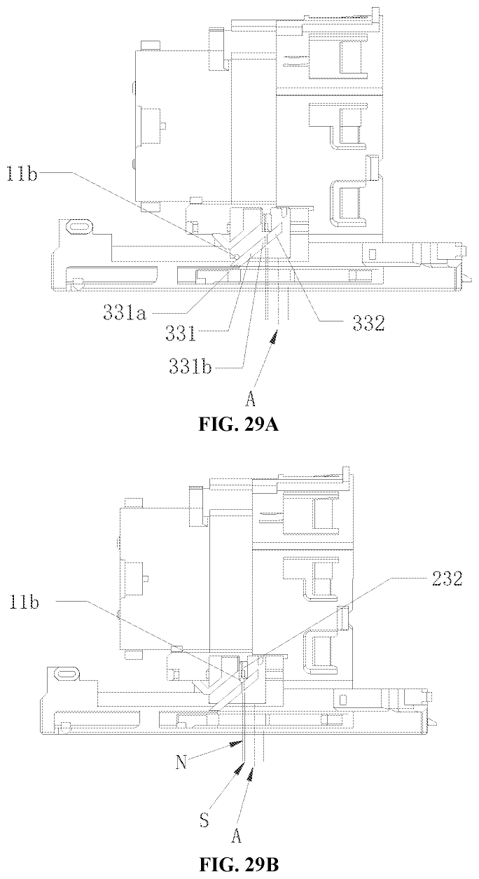

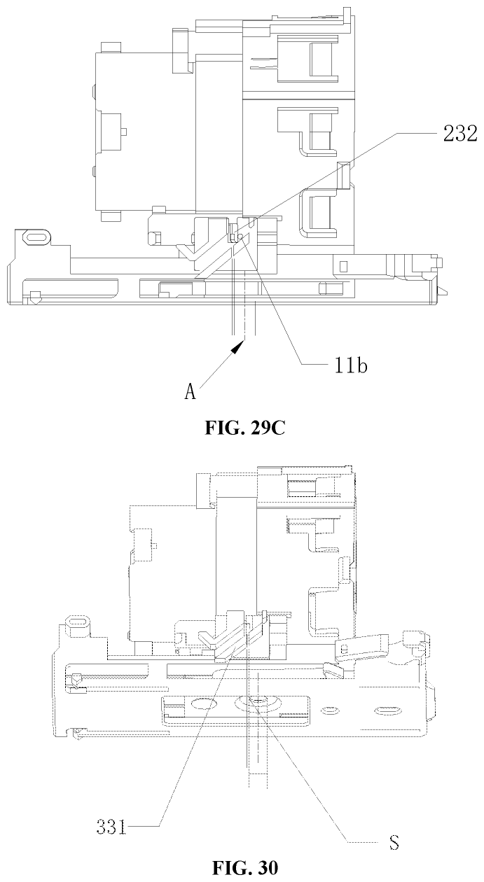

Referring to FIGS. 29A-30, in one embodiment, on the basis of exemplary embodiment three, the guiding portion 231 of exemplary embodiment three may be further divided into two portions including a guiding portion 331 and a holding portion 332. Size of the gap N between the guiding portion 331 and the holding portion 332 may be same as the size of the gap in exemplary embodiment four, that is, the size of the gap N may be less than the maximum diameter of the engaging portion 11b. Different from exemplary embodiment three, the guiding portion 331 may have a larger inclined slope than the guiding portion 231 in exemplary embodiment three.

The guiding portion 231 of exemplary embodiment three may be further divided into the guiding portion 331 and the holding portion 332, where the guiding portion 331 may also include a first end portion 331a and a second end portion 331b. As shown in FIG. 29A, initially, the engaging portion 11b may climb from the first end portion 331a to the second end portion 331b; when reaching the gap N (as shown in FIG. 29B), since the size of the gap N is less than the diameter of 11b, under the action of the insertion force of the toner cartridge installation, the engaging portion 11b may completely pass through the gap N to reach the holding portion 332 (same as exemplary embodiment four); after reaching the holding portion 332, the second force-receiving block 232a of the locking part 232 may protrude from the gap 231d using a timing node and manner same as that in exemplary embodiment three and prevent the engaging portion 11b from sliding down (as shown in FIG. 29C).

It should be noted that the position of the gap N between the guiding portion 331 and the holding portion 332 in one embodiment may be that, along the direction in parallel with the rotation axis of the toner cartridge, the gap N may be farther away from the toner outlet opening 140 compared to the discharge channel (the center line A in FIG. 29C represents the center line of the discharge channel). Such gap N may be actually the end of the guiding portion 331, such that when the engaging portion 11b is located at the position participating in the formation of the discharge channel to discharge the toner out of the toner cartridge, the engaging portion 11b may not be located on the guiding portion 331, which is the objective of exemplary embodiment six. That is, when a plane (a line S in FIG. 29B) is perpendicular to the rotation axis and passes through the discharge channel, the plane may not pass through the guiding portion 331. In the drawings, the gap N may be located outside the line S, and along the direction in parallel with the rotation axis of the toner cartridge, the gap N may be farther away from the toner outlet opening 140 compared to the line S. When the gap N has different widths along the direction perpendicular to the rotation axis, optionally, the minimum width of the gap N may be located outside the line S and away from the toner outlet/toner cartridge body 120 relative to the line S.

### Exemplary Embodiment Seven

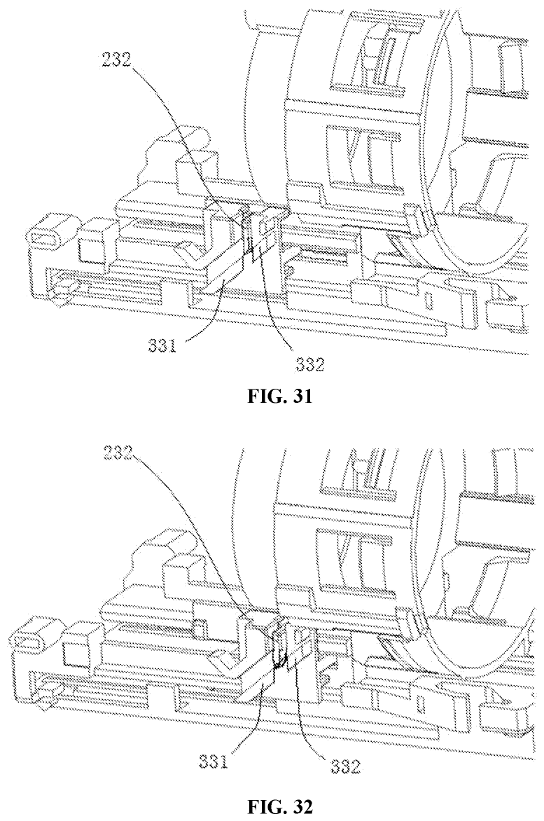

Referring to FIGS. 31-32, in one embodiment, on the basis of exemplary embodiment six, the locking part 232 may not only pass through the gap 231d, and at least a part of the locking part 232 along the vertical direction (the first direction) adjacent to the bottom of the toner cartridge may also be located at the gap N between the guiding portion 331 and the holding portion 332. Therefore, the gap N may be filled up when the locking part 232 protrudes out. When the engaging portion 11b climbs to the holding portion 332, there is basically no gap between the locking part 232 and the holding portion 332, which may not result in that the engaging portion 11b slides downward from the gap caused by an undesired gap due to tolerance, shaking and the like.

### Exemplary Embodiment Eight

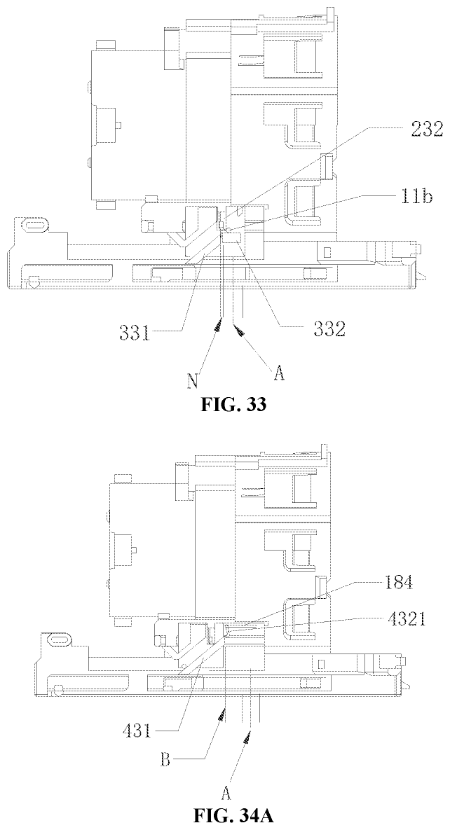

Referring to FIG. 33, exemplary embodiment six is combined with exemplary embodiment four or embodiment seven. In one embodiment, on the basis of exemplary embodiment six, optionally, the holding portion 332 may be configured as a planar structure (as exemplary embodiment four); that is, the holding portion 332 may extend along the second direction, and the second direction may be in parallel with the extending direction of the rotation axis of the toner cartridge, such that there is no change in the distance between the holding portion 332 and the rotation axis of the toner cartridge.

Furthermore, when the locking part 232 protrudes out of the gap 231d, the gap N between the guiding portion 331 and the holding portion 332 may also be filled (as exemplary embodiment seven). There is basically no gap between the locking part 232 and the holding portion 322, which may not result in that the engaging portion 11b slides downward from the gap caused by an undesired gap due to tolerance, shaking and the like.

### Exemplary Embodiment Nine

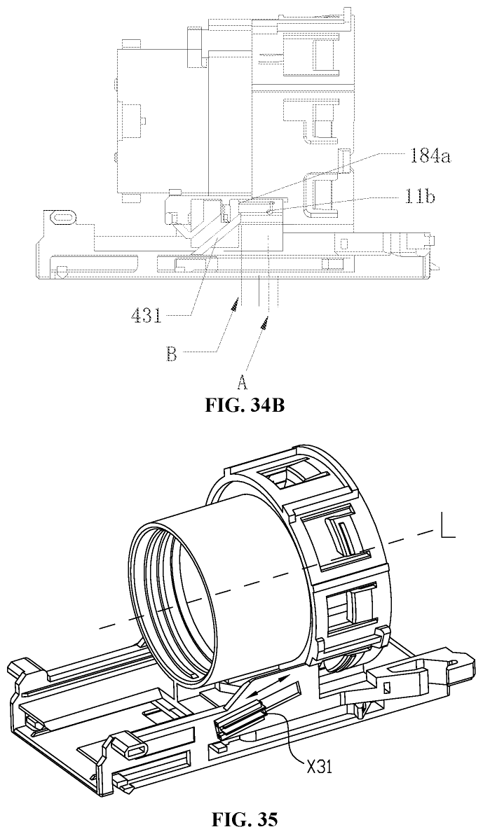

Referring to FIGS. 34A-34B, in one embodiment, on the basis of exemplary embodiment three, the movable holding portion of exemplary embodiment five is combined, that is, the movable guiding portion 431 may be combined with the movable holding portion 4321. The difference from exemplary embodiment three is that the guiding portion 431 may only move to a preset position (the position B as shown in FIG. 34A), and then the movable holding portion 4321 may carry the engaging portion 11b (the holding portion 1321 is same as that in exemplary embodiment five); and the movement distance of the guiding portion 431 may be shortened compared with exemplary embodiment three, but there is no need to limit position shortening. Since the holding portion 4321 has the movement distance in one embodiment, when the engaging portion 11b is located at the position participating in the formation of the discharge channel to discharge the toner out of the cartridge, the engaging portion 11b must not be located on the guiding portion 431. That is, when a plane is perpendicular to the rotation axis and passes through the discharge channel, the plane may not pass through the guiding portion 431.

In addition, in one embodiment, it should be noted that the locking part 232 may not be disposed.

The holding portion 4321 may carry the engaging portion 11b to move to the position of the line A in FIG. 34B, and the carbon toner may be discharged out of the toner cartridge through the discharge channel.

After the engaging portion 11b is received by the holding portion 4321, the guiding portion 431 may stay at the position B, and the holding portion 4321 wait for the return operation (uninstalling the toner cartridge) to “send” the engaging portion 11b to the guiding portion 431. The B position may be located adjacent to one end portion 184a of the guiding groove 184.

In addition, when the toner cartridge is uninstalled, the holding portion 4321 may move along the opposite direction, and the movable guiding portion 431 and the movable holding portion 4321 may be abutted against each other to receive the engaging portion 11b, and there is basically no bad connection during the docking process.

### Exemplary Embodiment Ten

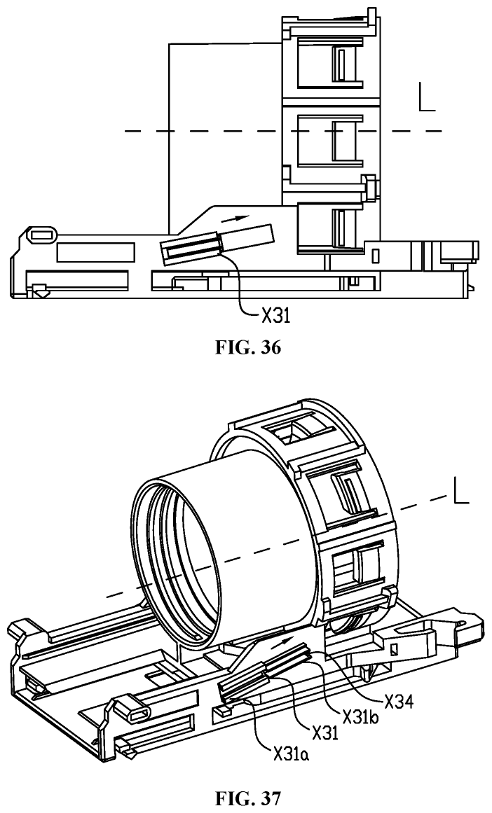

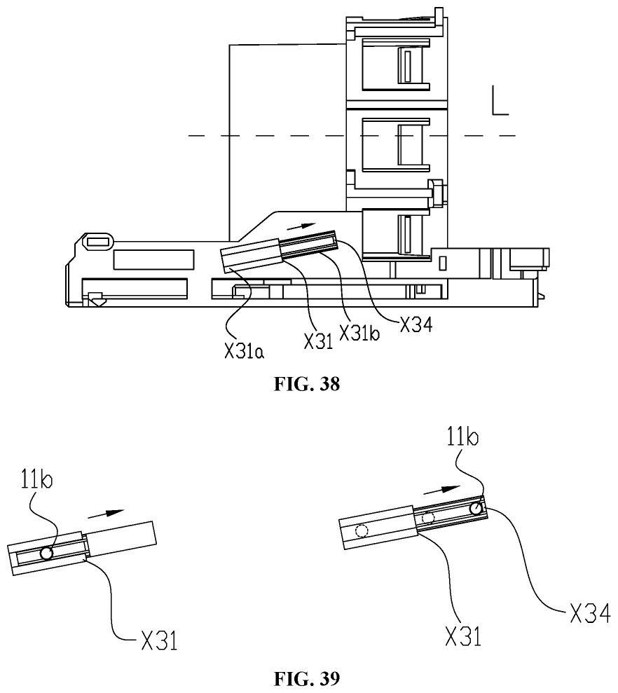

Referring to FIGS. 35-39, on the basis of exemplary embodiment one, another guiding portion X31, which can be extended and folded, is provided in one embodiment. For example, the guiding portion X31 may include a first portion X31a, a second portion X31b and a pushing part. The first portion X31a may be fixedly disposed on the sidewall of the fixed toner outlet plate 180, and a rail may be preset on the first portion X31a. The second portion X31b may be a movable structure, and a third force-receiving block X34 may be also disposed on the second portion X31b; and the third force-receiving block X34 may be disposed at the rear end of X31b (the end of the second portion X31b closer to the toner cartridge body 120 is the rear end). The second portion X31b may slide in the preset rail relative to the first portion X31a, and the sliding trajectory of the second portion X31b may be adjacent to the rotation axis L and the connecting part 160. That is, the rails of the guiding portion X31 and the first portion X31a may be configured to be inclined along a straight line that is not in parallel with the rotation axis L; and the second portion X31b may slide along the inclined straight line, such that the guiding portion X31 may expand and fold. When the engaging portion 11b is not guided to move, the second portion X31b may be pushed forward by the pushing part (such as a spring, an elastic sponge, a magnet or the like) and may be overlapped with the majority of the first portion X31a (in a folded state). The pushing part may be disposed at the front end of the first portion X31a (the end of the first portion X31a away from the toner cartridge body 120). The trajectory of the guiding portion X31 guiding the movement of the engaging portion 11b is that the engaging portion 11b may first enter the area where the second portion X31b is overlapped with the first portion X31a; as the installation of the toner cartridge continues, the engaging portion 11b may be abutted against the third force-receiving block X34 at the rear end of the second portion X31b and push the third force-receiving block X34 to make the second portion X31b slide and extend adjacent to the rotation axis L and the connecting part 160 along the preset rail; and after the engaging portion 11b reaches the position, the receiving opening 11a may be finally kept open.

### Exemplary Embodiment Eleven

On the basis of exemplary embodiment two, another holding portion 132 is provided in one embodiment.

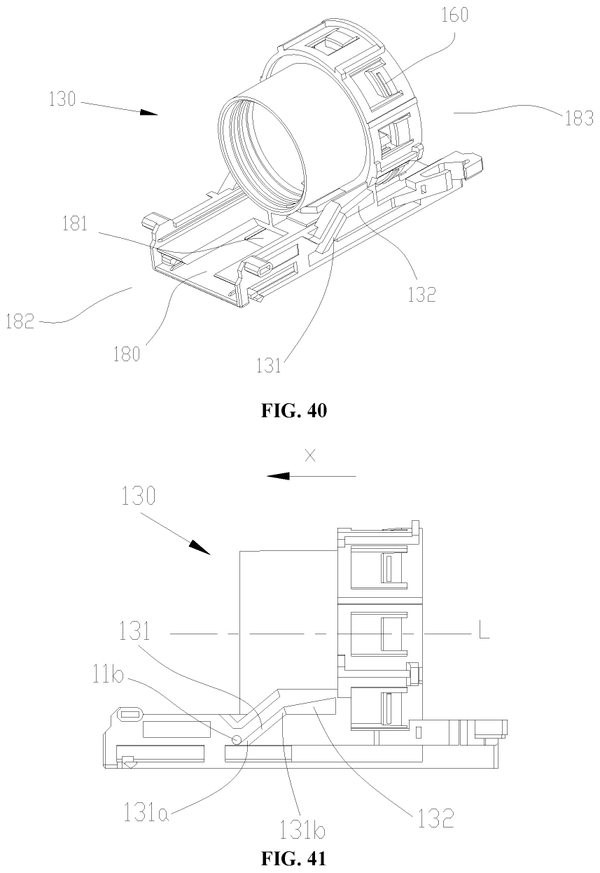

Referring to FIGS. 40-42, FIGS. 41 and 42 respectively illustrate that the toner cartridge is located at the first position where the receiving opening 11a is to-be-opened; and the toner cartridge is located at the second position where the discharge channel is formed and the receiving opening 11a is opened. As shown in FIGS. 40-42, the toner outlet structure 130 may include the guiding portion 131 and the holding portion 132, where the holding portion 132 may be configured to be connected to the second end portion 131b of the guiding portion 131. In one embodiment, the holding portion 132 may be formed by a frictional elastic body structure, for example, may be implemented using a sponge manner.

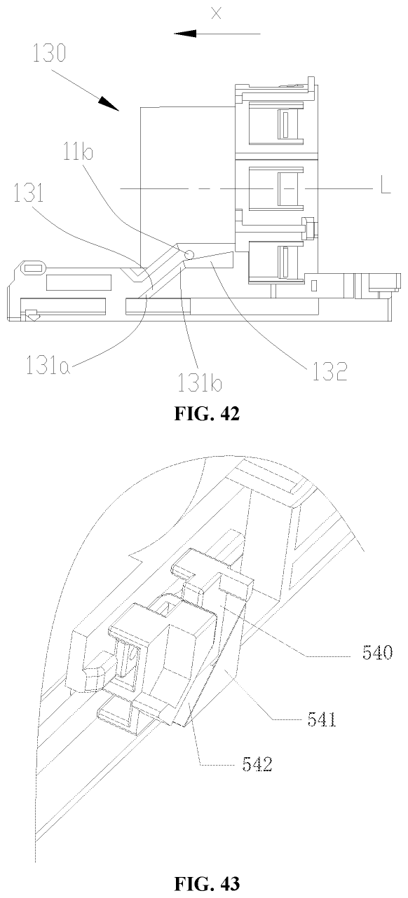

As shown in FIGS. 41 and 42, when the toner cartridge is installed in the electronic image-forming apparatus, the toner cartridge may be located at the first position that the receiving opening 11a is to-be-opened. The engaging portion 11b for opening and closing the receiving opening 11a may be located at the first end portion 131a of the guiding portion 131. As the toner cartridge moves further along the second direction (the X direction in FIG. 41), the guiding portion 131 may guide the engaging portion 11b to gradually climb to the second end portion 131b. At this point, the toner cartridge may be at the second position that the discharge channel is formed and the receiving opening 11a is opened. The holding portion 132 may hold the engaging portion 11b on the holding portion 132 by utilizing high friction, such that the position of opening the receiving opening 11a may be held, thereby successfully replenishing the developer in the toner cartridge in the electronic image-forming apparatus.

### Exemplary Embodiment Twelve

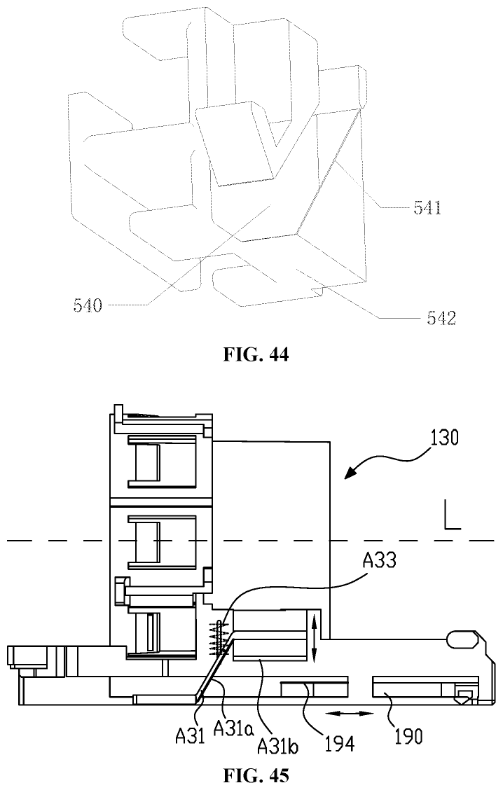

As shown in FIGS. 43 and 44, on the basis of above-mentioned embodiments, the guiding portion 541 may be disposed as a sheet-like structure, and the manner of making the guiding portion 541 to be in contact with the engaging portion 11b may be linear contact. Optionally, for the convenience of molding, the bottom of the guiding portion 541 may have a certain width, and the part in contact with the engaging portion 11b may be an inclined line structure, that is, the cross section of the guiding portion 541 may be a triangular structure. For example, the guiding portion 541 may be a sheet drawn out from a base portion 540; and the guiding portion 541 may be connected to the base portion 540 through a connecting surface 542. The connecting surface 542 may be a plane in parallel with the rotation axis.

### Exemplary Embodiment Thirteen

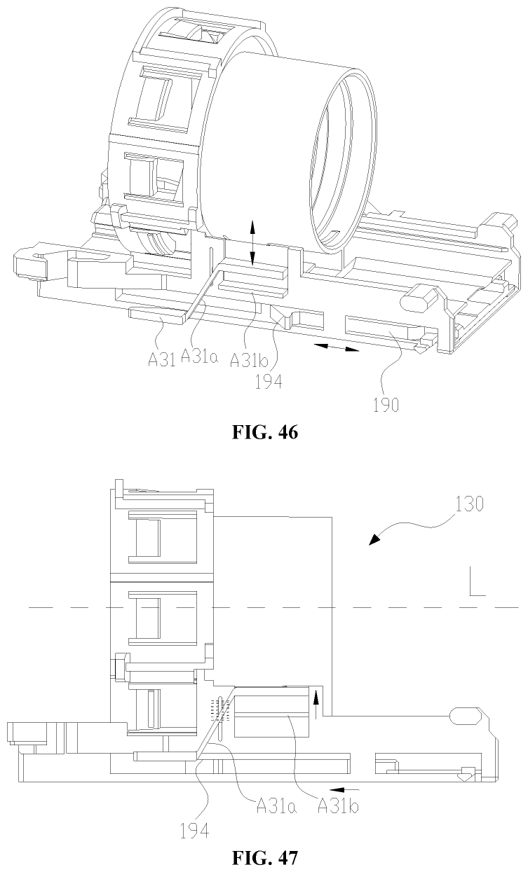

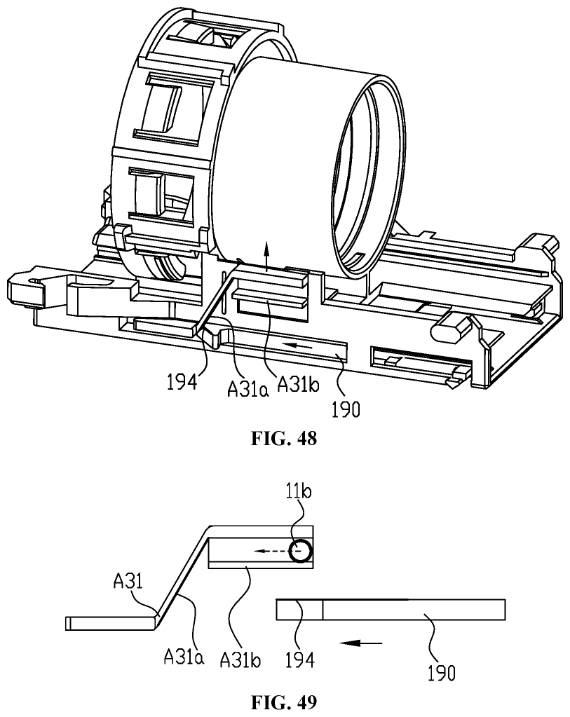

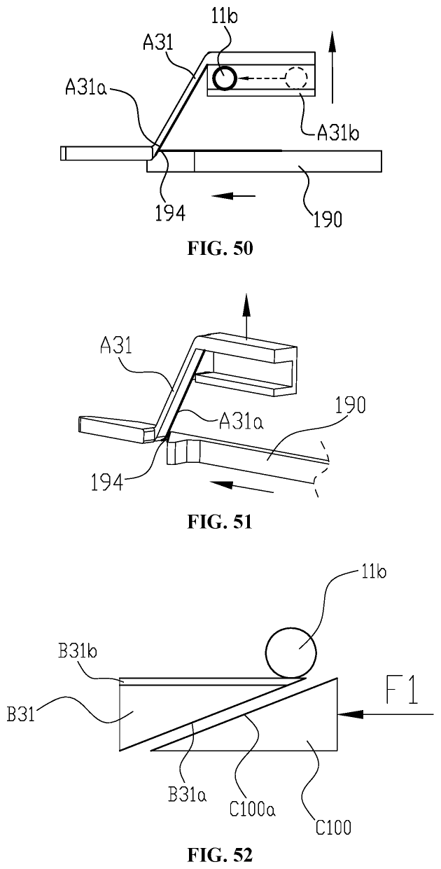

As shown in FIGS. 45-51, the structures not shown refer to above-mentioned embodiments. In one embodiment, guiding the engaging portion 11b to open the receiving opening 11a is realized by moving the guiding portion A31 “up and down (ascend and descend)” on the toner outlet structure 130. The guiding portion A31 may be movably disposed on the fixed toner outlet plate 180, and a guiding rail for sliding the guiding portion A31 may be disposed on the fixed toner outlet plate 180. The guiding portion A31 may be disposed with an abutted portion A31a, a carrying portion A31b and a third elastic part A33. The abutted portion A31a may be disposed obliquely with respect to the rotation axis L of the toner cartridge, and the carrying portion A31b may be connected to one end of the abutted portion A31a adjacent to the rotation axis L. The carrying portion A31b may be a groove-shaped structure, and the extending direction of the groove may be in parallel with the rotation axis L. The third elastic part A33 may be connected to the fixed toner outlet plate 180, and one end of the third elastic part A33 may be abutted against the abutted portion A31a. Optionally, the third elastic part A33 may also be abutted against the carrying portion, as long as the third elastic part A33 can generate elastic force on the guiding portion A31. Rod bodies may be disposed on two sides of the movable toner outlet plate 190 at the bottom of the toner outlet structure 130 and abutting portions 194 may be disposed on the rod bodies. When the engaging portion 11b is not guided to move (not installed), the third elastic part A33 located on the toner outlet structure 130 may press down the guiding portion A31 by elastic force to make the carrying portion A31b away from the rotation axis L, and the abutting portion 194 of the movable toner outlet plate 190 may not act on the abutted portion A31a of the guiding portion A31.

When the toner cartridge is installed in the electronic image-forming apparatus, the engaging portion 11b may enter the front end of the carrying portion A31b of the guiding portion A31 that has not been lifted. As the toner cartridge continues to be installed, the movable toner outlet plate 190 and the fixed toner outlet plate 180 may move relatively. The abutting portion 194 of the movable toner outlet plate 190 may first be abutted against the abutted portion A31a of the guiding portion A31 and move inward to push the guiding portion A31 to move upward along the preset guiding rail as a whole (move upward to the direction adjacent to the rotation axis L) as the movement of the movable toner outlet plate 190; and the carrying portion A31b of the guiding portion A31 may also move upward to lift the engaging portion 11b to move upward. With relative horizontal movement of the movable toner outlet plate 190, upward movement of the guiding portion A31 and complete installation of the toner cartridge, the engaging portion 11b may finally move to the rear end of the carrying portion A31b and may be closer to the rotation axis L while keeping the receiving opening 11a open.

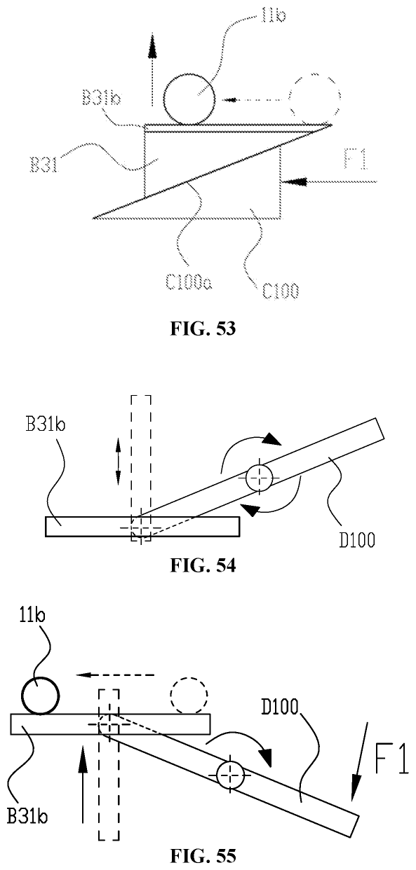

As shown in FIGS. 52-53, the key structure of above-mentioned embodiment thirteen may also be realized by abutting against the structure in the electronic image-forming apparatus. The pushed portion C100 may be disposed on the front or side of the front end of the toner cartridge 100 (e.g., same end as the toner outlet structure 130). When the toner cartridge is installed in the electronic image-forming apparatus, the front or side of the pushed portion C100 may receive an abutting thrust F (reaction force) of the structure (inner wall or protrusion) in the electronic image-forming apparatus to make the pushed portion C100 move relatively horizontally; and the abutting portion C100a (inclined surface) on the pushed portion C100 may be abutted against the abutted portion B31a (inclined surface) on the lower side of the guiding portion B31 to push the abutted portion B31 to move up as a whole, and finally drive the engaging portion 11b on the carrying portion B31b to move upward. Similarly, a third elastic part may be disposed on the pushed portion C100 and the guiding portion B31. When the pushed portion C100 and the guiding portion B31 are not in contact with each other, the pushed portion C100 may be pushed away from the guiding portion B31 by the third elastic part, and the guiding portion B31 may move away from the rotation axis L by the reverse push of the third elastic part.

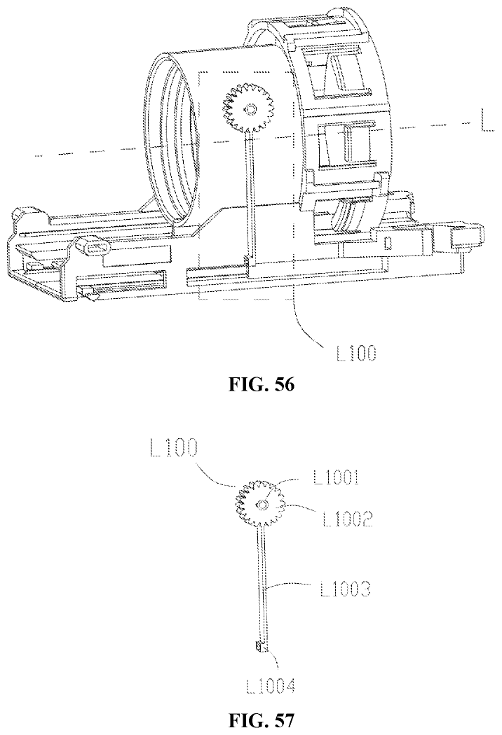

In addition, as shown in FIGS. 54-55, the structure of above-mentioned pushed portion may also be replaced by a swing rod shape. The pushed portion D100 may be in the shape of a swing rod, which may swing around the center point and control the up and down movement of the guiding portion. For example, when the engaging portion 11b is not guided and moved (uninstalled), the front end of the pushed portion D100 may be not pressed down by an external force, and the guiding portion connected to the rear end of the pushed portion D100 may be in a state away from the rotation axis L. When the front end of the pushed portion D100 is pressed down by the thrust F during the installation of the toner cartridge in the electronic image-forming apparatus to make the front end of the pushed portion to swing and make the rear end of the pushed portion D100 move up to drive the guiding portion to move up along the preset rail, the carrying portion B31b may also drive the engaging portion 11b to move upward to be close to the rotation axis L.

### Exemplary Embodiment Fourteen

Referring to FIGS. 56-59, the structures not shown refer to above-mentioned embodiments. In one embodiment, guiding the engaging portion 11b to open the receiving opening 11a is realized by moving the guiding portion L100 “up and down (ascend and descend)” on the toner outlet structure 130. The guiding portion L100 may include a rotating wheel L1002, a rotating wheel axis L1001, a rotating rod L1003, and an engaged portion L1004. The rotating wheel L1002 may be located farther away from the fixed toner outlet plate 180 than the rotation axis L. The rotating wheel axis L1001 may be located at the center of the wheel L1002. The rotating wheel L1002 may be connected to the rotating rod L1003 and linked with the rotating rod L1003. Optionally, the rotating wheel L1002 may be a gear, and the rotating rod L1003 may be linked with the teeth of the gear. The rotating rod L1003 may extend along the direction perpendicular to the rotation axis L, one end of the rotating rod L1003 may be linked with the rotating wheel L1002, and the other end of the rotating rod L1003 may extend to a position adjacent to the fixed toner outlet plate 180. The end of the rotating rod L1003 may include the engaged portion L1004 cooperated with the engaging portion 11b. The engaged portion L1004 may be a groove capable of accommodating the engaging portion 11b.

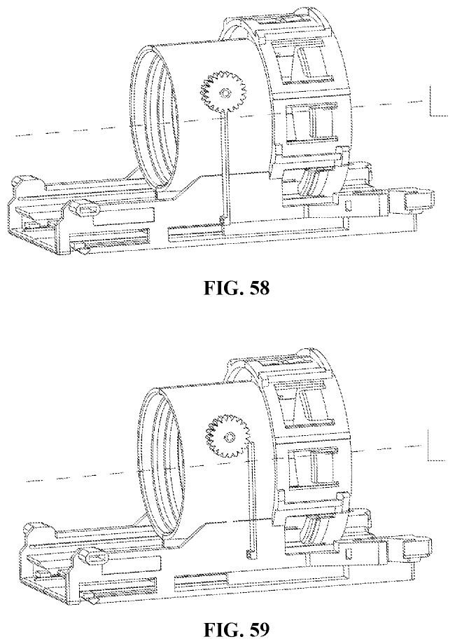

When the toner cartridge 100 is installed in the developer replenishing apparatus, the engaging portion 11b may be inserted in the engaged portion L1004. When the toner cartridge moves towards the developer replenishing apparatus, the engaging portion 11b may push the engaged portion L1004 to move in the X direction, and the engaged portion L1004 may be linked to make the rotating wheel L1002 rotate (counterclockwise rotation viewed from the angle of FIGS. 58-59). Due to the characteristics of the gear, the rotating wheel L1002 may drive the rotating rod L1003 and the engaged portion L1004 to climb upward (that is, move toward the direction of the rotating axis L), thereby driving the connecting part 11b to move upward to keep the receiving opening 11a open.

### Exemplary Embodiment Fifteen

Exemplary embodiment fifteen is an improvement on the basis of exemplary embodiment one. A new toner outlet structure, which may also include a control mechanism, is provided in one embodiment.

Solution One of Exemplary Embodiment Fifteen

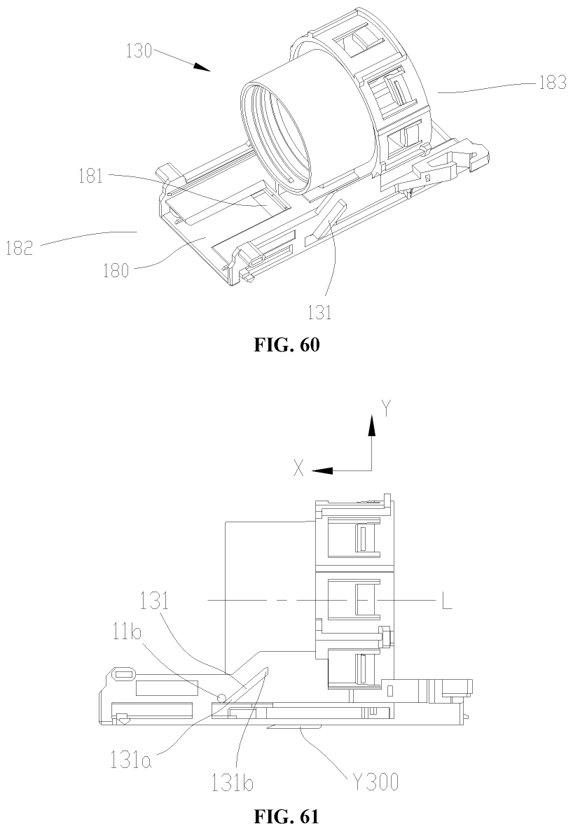

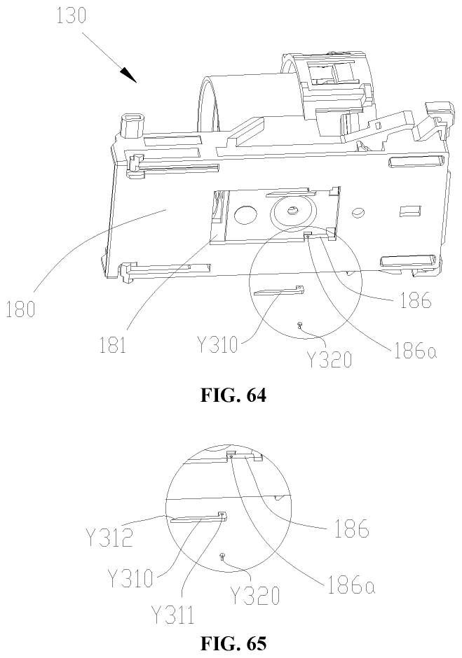

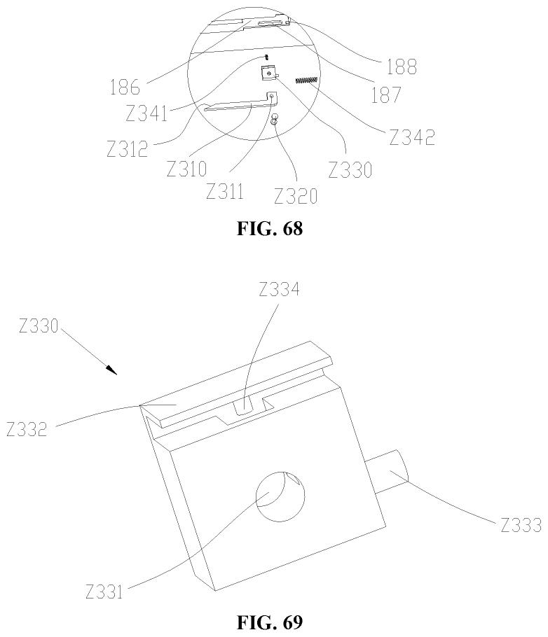

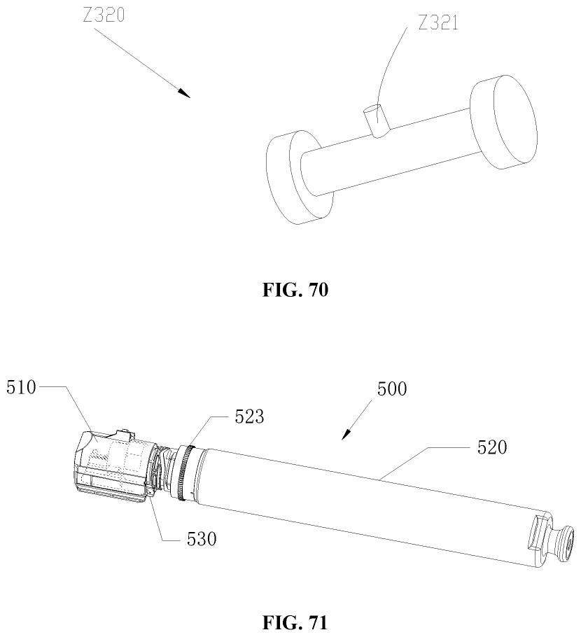

As shown in FIGS. 60-70, the toner outlet structure 130 may include a guiding portion 131 and a control mechanism Y300. The guiding portion 131 may be connected to the sidewall of the fixed toner outlet plate 180. In addition, the guiding portion 131 may include the first end portion 131a and the second end portion 131b; and the second end portion 131b may be closer to the rotation axis L than the first end portion 131a.

For example, the control mechanism Y300 may be disposed on the fixed toner outlet plate 180, and the control mechanism Y300 may include a pushing part Y310 and a connecting part Y320, where the pushing part Y310 is a bar-shaped structural part. One end of the pushing part Y310 may be disposed with an axle hole Y311, and the other end of the pushing part Y310 may be disposed with an inclined surface Y312. Furthermore, the opening 181 of the fixed toner outlet plate 180 may be disposed with an engaging portion 186, and a through hole 186a may be formed on the engaging portion 186. The connecting part Y320 may successively pass through the axle hole Y311 and the through hole 186a of the pushing part Y310 to be fixed on the engaging portion 186, such that the pushing part Y310 may be installed on the fixed toner outlet plate 180, and the pushing part Y310 may rotate around the connecting part Y320. Optionally, the connecting part Y320 may be a rotation axle.

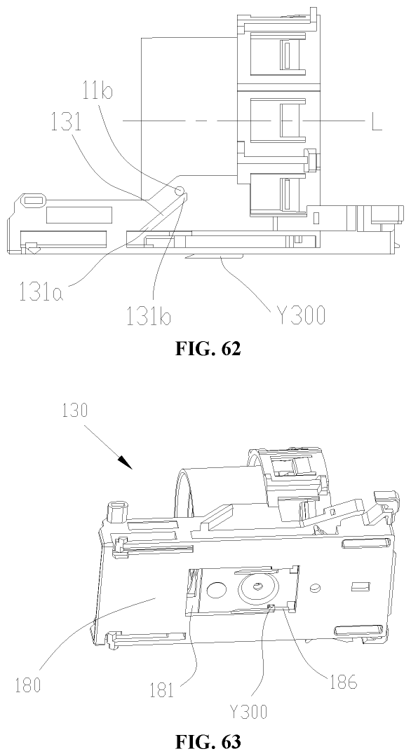

FIG. 61 illustrates a schematic of the engaging portion 11b located at the first end of the guiding portion provided by solution one in exemplary embodiment fourteen of the present disclosure. FIG. 62 illustrates a schematic of the engaging portion 11b located at the second end of the guiding portion provided by solution one in exemplary embodiment fourteen of the present disclosure. When the toner cartridge is installed in the electronic image-forming apparatus, the engaging portion 11b for opening and closing the receiving opening 11a may be located at the first end portion 131a of the guiding portion 131. As the toner cartridge moves along the X direction, the guiding portion 131 may guide the engaging portion 11b to gradually climb to the second end portion 131b. At this point, the developer receiving portion 11 may move upward with the movement of the engaging portion 11b, and the receiving opening 11a may also be opened accordingly. The developer receiving portion 11 may be at the first position at this point; that is, the pushing part Y310 of the control mechanism Y300 may move to the position that the pushing part Y310 contacts and interferes with the developer receiving portion 11. The inclined surface Y312 of the pushing part Y310 may be abutted against a base (not shown) of the developer receiving portion 11. Meantime, as the toner cartridge continues to move, the pushing part Y310 may receive the force of the base of the developer receiving portion 11 and rotate around the connecting part Y320, thereby driving the developer receiving portion 11 to continue moving upward. Finally, under the action of the pushing part Y310, the developer receiving portion 11 may move to the position that the developer receiving portion 11 forms a through developer discharge channel with the receiving opening 11a in the toner cartridge. At this point, the developer receiving portion 11 may be at the second position, such that the developer in the toner cartridge may be successfully replenished into the electronic image-forming apparatus.

Solution Two of Exemplary Embodiment Fifteen

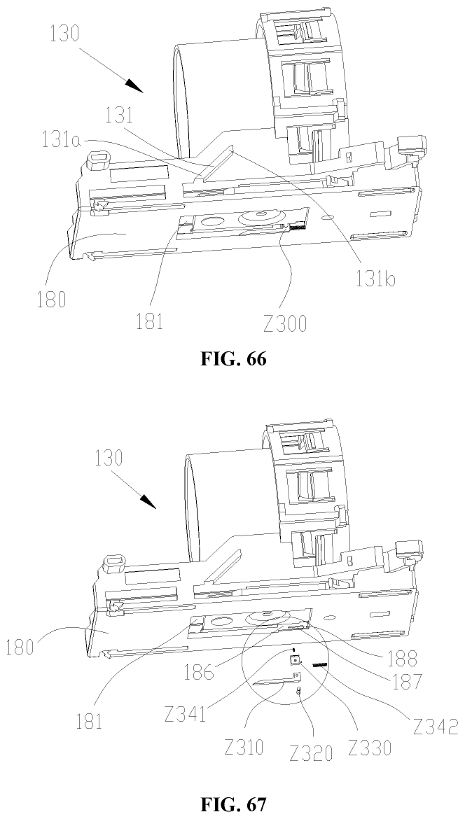

As shown in FIGS. 66-70, the second solution is an improvement of the control mechanism on the basis of the first solution to adapt to the developer replenishing apparatuses of the electronic image-forming apparatuses with different structures.

The toner outlet structure 130 may include the guiding portion 131 and a control mechanism Z300, where the guiding portion 131 may include the first end portion 131a and the second end portion 131b; and the control mechanism Z300 may be disposed on the fixed toner outlet plate 180.

For example, the control mechanism Z300 may include a pushing part Z310, a connecting part Z320 and a movable part Z330, where one end of the pushing part Z310 may be disposed with an axle hole Z311, and the other end of the pushing part Z310 may include an inclined surface Z312. Furthermore, the movable part Z330 may be disposed with a connecting hole Z331, a bent supporting portion Z332, and a first protrusion Z333. A second protrusion Z334 may be further disposed on the supporting portion Z332, and a channel may be formed inside the movable part Z330 between the second protrusion Z334 and the connecting hole Z331. In addition, the connecting part Z320 may further include a fixing column Z321, the connecting part Z320 may be a rotation axle, and the fixing column Z321 may be formed on the circumferential surface of the rotation axle.

The connection relationship between the control mechanism Z300 and the fixed toner outlet plate 180 is as follows. The connecting part Z320 may pass through the axle hole Z311 of the pushing part Z310 and the connecting hole Z331 of the movable part Z330 in sequence, such that the pushing part Z310, the connecting part Z320 and the movable part Z330 may be movably connected with each other. Furthermore, in order to allow the pushing part Z310 to move up and down in the movable part Z330, the pushing part Z310 and the connecting part Z320 may be connected by a first elastic part Z341. One end of the first elastic part Z341 may be fixed on the second protrusion Z334 of the movable part Z330, and the other end of the first elastic part Z341 may be fixed on the fixing column Z321 of the connecting part Z320. The pushing part Z310 and the connecting part Z320 are connected with each other, such that the connecting part Z320 may drive the pushing part Z310 to move up and down together. After the control mechanism Z300 is assembled, entire control mechanism Z300 may be installed on the fixed toner outlet plate 180. Optionally, one end of the connecting part Z320 may be locked into the guiding rail 187 of the engaging portion 186, and the movable part Z330 may be connected to the engaging portion 186 through the second elastic part Z342. One end of the second elastic part Z342 may be fixed on the first protrusion Z333 of the movable part Z330, and the other end of the second elastic part Z342 may be fixed on the connecting column 188 of the engaging portion 186, such that whole control mechanism Z300 may move left and right along the guiding rail 187 horizontally.

Compared with the developer replenishing apparatus 8 (see FIG. 2A) in solution one, the developer replenishing apparatus in solution two may include an additional step-shaped blocking portion (not shown in drawings). When the toner cartridge is installed in the electronic image-forming apparatus, as the toner cartridge moves along the X direction (as shown in FIG. 61), the pushing part Z310 of the control mechanism Z300 may move to the position that the pushing part Z310 contacts and interferes with the blocking portion. At this point, the pushing part Z310 may receive the force of the blocking portion and overcome the elastic force of the first elastic part Z341 to move upward along the Y direction (as shown in FIG. 61), thereby avoiding the interference of the blocking portion. As the toner cartridge continues to move, the pushing part Z310 may be no longer in contact with the blocking portion, and the pushing part Z310 that has lost force may return to its original state along the direction opposite to Y; the engaging portion 11b for opening and closing the receiving opening 11a may be located at the first end portion 131a of the guiding portion 131; and the guiding portion 131 may guide the engaging portion 11b to gradually climb to the second end portion 131b. At this point, the developer receiving portion 11 may move upward with the movement of the engaging portion 11b, and the receiving opening 11a may be also opened accordingly. The developer receiving portion 11 may be at the first position at this point. That is, the pushing part Z310 of the control mechanism Z300 may move to the position that the pushing part Z310 contacts and interferes with the developer receiving portion 11; and the inclined surface Z312 of the pushing part Z310 may move to the position in contact with the developer receiver 11. At this point, the developer receiving portion 11 may apply a force to the pushing part Z310, such that the pushing part Z310 may drive the movable part Z320 to overcome the elastic force of the second elastic part Z342 and move along the guiding rail 187 in the direction opposite to the X direction, thereby avoiding the rigid contact between the pushing part Z310 and the blocking portion. However, due to continuous movement of the toner cartridge, the force exerted by the pushing part Z310 on the blocking portion may be greater than the force exerted by the blocking portion on the pushing part Z310, such that the pushing part Z310 may drive the developer receiving portion to continue to move upward along the Y direction. Finally, under the action of the pushing part Z310, the developer receiving portion 11 may move to the position that the toner outlet opening in the toner cartridge and the receiving opening 11a form a through developer discharge channel. At this point, the developer receiving portion 11 may be at the second position, such that the developer in the toner cartridge may be successfully replenished into the electronic image-forming apparatus.

### Exemplary Embodiment Sixteen

A toner cartridge with a different structure is provided in one embodiment. In above-mentioned embodiments, as the toner cartridge is installed and uninstalled in the electronic image-forming apparatus, the engaging portion 11b in the electronic image-forming apparatus may reciprocally slide relative to the guiding portion of the toner cartridge. Therefore, the reciprocating activity may inevitably cause a certain degree of wear between the toner cartridge and the electronic image-forming apparatus. In particular, since the toner cartridge itself is a replaceable consumable, in the long-term process, the electronic image-forming apparatus may experience uninstallation and installation of a same toner cartridge and the replacement of a new toner cartridge. Even if the upper guiding portion of the toner cartridge is worn out after long-term use, the wear of the toner cartridge may be well avoided by replacing new toner cartridge. However, it is difficult to update the engaging portion 11b of the electronic image-forming apparatus. Therefore, the engaging portion 11b of the electronic image-forming apparatus may be easily to be worn to an unfavorable degree, such as a dimensional change of the engaging portion 11b, wear and tear of the engaging portion 11b and the like, thereby affecting reciprocating movement of the engaging portion 11b to drive opening and closing of the receiving opening 11a.

Therefore, exemplary embodiment sixteen is different from above-mentioned embodiments in that the toner cartridge in exemplary embodiment sixteen may hardly cause wear of the engaging portion 11b in the electronic image-forming apparatus, which may greatly extend the service life of the engaging portion 11b and reduce the frequency and cost of repair and maintenance of the electronic image-forming apparatus.

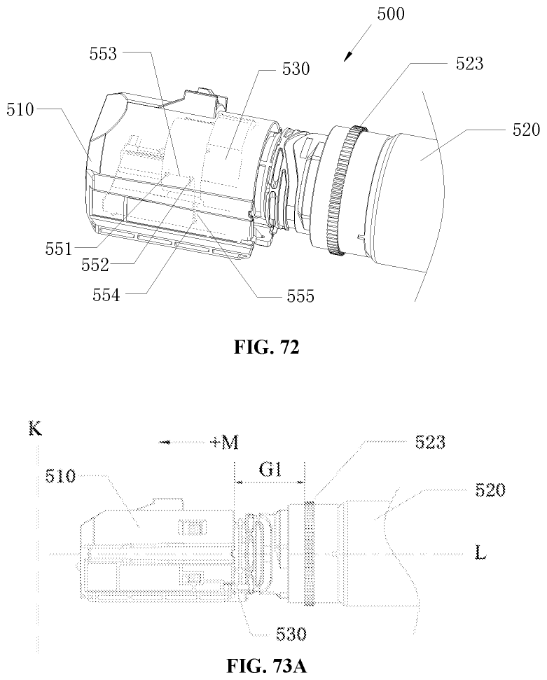

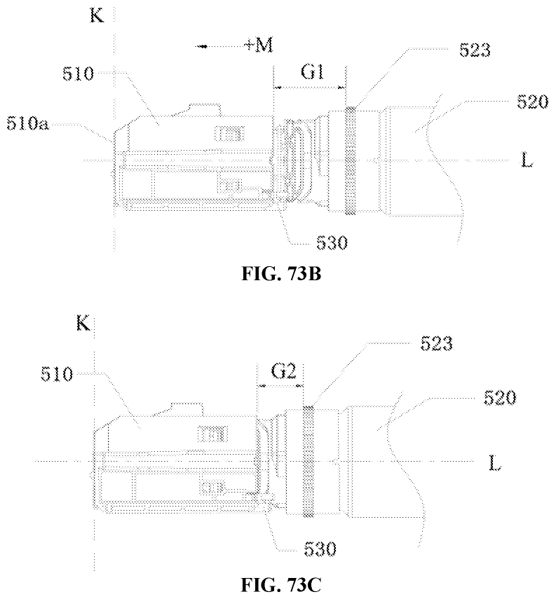

The toner cartridge 500 in one embodiment may include a housing 510, a toner cartridge body 520 and a toner outlet structure 530. A ring gear 523 may be disposed on the toner cartridge body 520. The housing 510 may wrap the toner outlet structure 530. Referring to FIGS. 71 and 72, FIG. 72 is a partially enlarged view of the housing in FIG. 71. Different from the housing in above-mentioned embodiments which completely and fixedly wraps the toner outlet structure, in one embodiment, the housing 510 and the toner outlet structure 530 may be relatively movably cooperated. For example, before being installed into the electronic image-forming apparatus, the housing 510 of the toner cartridge 500 and the toner outlet structure 530 may be relatively movable with a certain amount of movement therebetween. As shown in FIG. 73A, there is a first spacing between the housing 510 and the toner outlet structure 530 before being installed in the electronic image-forming apparatus and when being installed in the electronic image-forming apparatus. The first spacing may be, for example, the distance between the end of the housing 510 adjacent to the toner cartridge body 520 and the end of the toner outlet structure 530 adjacent to the toner cartridge body 520. Since the toner outlet structure 530 and the ring gear 523 in one embodiment may be fixed on the cylinder 520, for the convenience of measurement, the “spacing” in one embodiment may be obtained by the distance between the housing 510 and the cylinder 520 or by the distance between the housing 510 and the ring gear 523. As shown in FIG. 73A, the first spacing may be the first distance G1 between the housing 510 and the ring gear 523. Furthermore, when the toner cartridge 500 reaches the position shown in FIG. 73B during the installation process along the +M direction, the housing 510 may preferentially reach at a preset position in the electronic image-forming apparatus relative to the toner outlet structure 530, that is, a dotted line K. At this point, at the downstream end 510a (the end away from the toner cartridge body 520) along the installation direction (+M direction), the housing 510 may reach the dotted line K and may be no longer move forward along the installation direction. At this momentary position, along the axial direction of the rotation axis L (or the installation direction of the toner cartridge), the first spacing may be still between the housing 510 of the toner cartridge and the toner outlet structure 530, and the first distance G1 may be still between the housing 510 and the ring gear 523. Furthermore, the toner cartridge 500 may continue to move forward along the installation direction from the state shown in FIG. 73B. At this point, since the housing 510 has been positioned and the housing 510 and the toner outlet structure 530 are relatively movable, in one embodiment, the cylinder body 520 may be pushed by the pushing force such as human and other factors to make the cylinder body 520 drive the toner outlet structure 530 on the cylinder body 520 to continue moving forward along the installation direction. Therefore, the toner outlet structure 530 may move relative to the housing 510 along the installation direction. During such process, the first spacing between the housing 510 and the toner outlet structure 530 and above-mentioned first distance G1 between the housing 510 and the ring gear 523 may begin to shorten. Finally, the state that the toner cartridge is fully installed as shown in FIG. 73C may be reached; and along the axial direction of the rotation axis (or the installation direction of the toner cartridge), a second spacing may be between the housing 510 of the toner cartridge and the toner outlet structure 530. A second distance G2 may be between the housing 510 and the ring gear 523. Due to structural design factors, under the premise of same measurement manner as the first spacing above, for example, the second distance may be the distance between the end of the housing 510 mentioned above adjacent to the toner cartridge body 520 and the end of the toner outlet structure 530 adjacent to the toner cartridge body 520. The second spacing using the second measurement manner may be 0 or a negative value, that is, the toner outlet structure may be completely wrapped in the housing. At this point, the ring gear 523 may have also reached a preset position along the direction of the rotation axis L of the toner cartridge to be meshed with a gear 9 (as shown in FIG. 2A) in the electronic image-forming apparatus. So far, according to one embodiment, it can be inferred that a movement amount Gn may be between the housing 510 and the toner outlet structure 530 along the direction of the rotation axis L; and the magnitude of Gn may be equal to the first spacing minus the second spacing therebetween. In one embodiment, it can be known by means of convenient measurement that: Gn=G1−G2.

As disclosed above, the toner cartridge in one embodiment may include the first position and the second position during the toner cartridge is installed in the electronic image-forming apparatus; when the toner cartridge is at the first position, along the axial direction of the rotation axis (or the installation direction of the toner cartridge), the first spacing may be between the housing of the toner cartridge and the toner outlet structure, and the first distance may be between the housing and the ring gear; and when the toner cartridge is at the second position, the second spacing may be between the housing of the toner cartridge and the toner outlet structure along the axial direction of the rotation axis (or the installation direction of the toner cartridge), and the second distance may be between the housing and the ring gear.

The action of lifting/dropping the engaging portion 11b to open/close the receiving opening 11a involved in the installation process of the toner cartridge from the first position to the second position and reverse uninstallation process in one embodiment is further described hereinafter. First, the toner outlet structure 530 of the toner cartridge 500 may include a connecting part 560 and a fixed toner outlet plate (not shown). The structure of the fixed toner outlet plate, same as above-mentioned embodiments, may be located at the bottom of the toner outlet structure 530, and the fixed toner outlet plate may include an opening for forming a discharge channel for discharging the toner out of the toner cartridge.

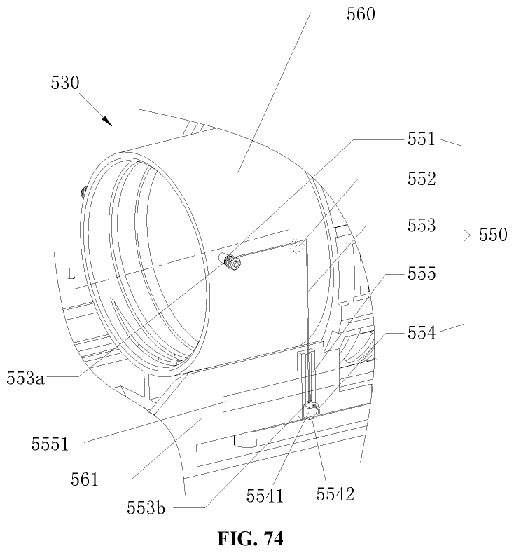

Furthermore, as shown in FIGS. 72 and 74, in one embodiment, the toner cartridge 500 may be disposed with a guiding portion 550. The guiding portion 550 may include a fixing part 551, a limiting part 552, a connecting part 553, a carrying part 554 and a guiding part 555 optionally disposed. For example, the carrying part 554 may be configured to carry the engaging portion 11b in the electronic image-forming apparatus, and the carrying part 554 may include an opening 5541 formed downstream along the installation direction of the toner cartridge and include a carrying surface 5542 facing upward along the vertical direction. The opening 5541 may be configured to receive the engaging portion 11b when the toner cartridge is installed and release the engaging portion 11b when the toner cartridge is uninstalled; and the carrying surface 5542 may be configured to carry the engaging portion 11b to move (lift/drop). The connecting part 553 may include a first end 553a and a second end 553b. The first end 553a may be connected to the fixing part 551, and the second end 553b may be connected to the carrying part 554. In one embodiment, the connecting part 553 may be a deformable component, such as a steel rope, a chain or the like. The fixing part 551 may be disposed on the connecting part 560, for example, may be configured as a cylindrical structure with an anti-disengaging flange; and the first end 553a of the connecting part 553 may be fixed on the circumference of the cylinder by winding or other means. The connecting part 560 may include a sidewall 561, and the guiding part 555 may be disposed on the sidewall 561. For example, the guiding part 555 may be a guiding groove structure perpendicular to the rotation axis L. The back of the carrying part 554 may be a structure that can cooperate with the guiding groove, such as a guiding column. The guiding column can be a cylinder or a capital I-shaped structure and may be difficult to disengage when being inserted in the guiding groove. The carrying part 554 may stably reciprocate along the direction perpendicular to the rotation axis L through the guiding part 555. Optionally, the guiding part 555 may be axially movable on the sidewall 561, for example, may be disposed with a guiding groove 5551. The guiding groove 5551 may be a groove on the connecting part 560 and extending along the installation direction. The guiding part 555 may be kept at the discharge channel when the toner cartridge is installed. The guiding part 555 may be always aligned at the center line A of the discharge channel in the installation direction. Obviously, the guiding part 555 may also be disposed on a separate part such as a sleeve that can move relative to the toner outlet structure, which may also make the guiding part 555 always be aligned with the center line A of the discharge channel, such that the guiding part 555 may also be adapted to the movement of the toner cartridge and up-and-down movement of the engaging portion 11b while guiding, and no jamming phenomenon may occur. Due to environmental constraints of the electronic image-forming apparatus, the engaging portion 11b itself may only move along the direction of the vertical rotation axis, such that the guiding part 555 may not be disposed, or guiding may be performed using other structures if permitted. In addition, the limiting part 552 may be disposed on a sidewall inside the housing 510 and may be a structure similar to the fixing part 551 such as a cylindrical structure or may be a roller structure disposed on a cylinder and capable of rotating around the cylinder. Since a gap is between the housing 510 and the toner outlet structure 530, the limiting part 552 may be configured to extend from a wall inside the housing facing toward the toner outlet structure to the surface of the connecting part 560 adjacent to the toner outlet structure 530 and to not interfere with the axial movement of the toner outlet structure 530 and the connecting part 560 relative to the housing 510. Therefore, the connecting part 553 may be disposed on the limiting part 552, and the connecting part 553 may slide relatively on the limiting part 552. Accordingly, when the limiting part 552 is above-mentioned roller structure, the effect of anti-wear similar to a pulley and relative smooth sliding may also be achieved.

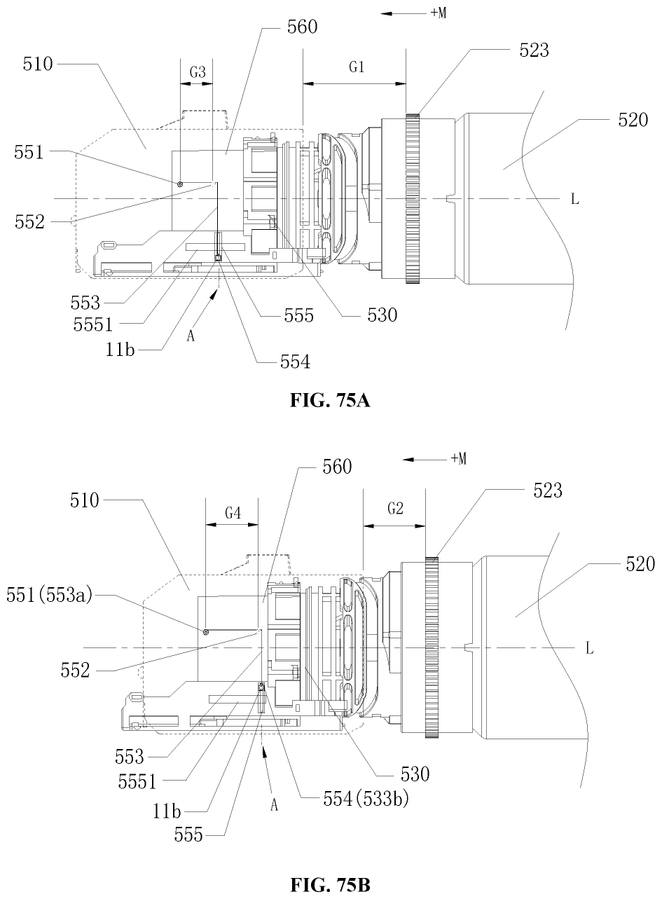

On the basis of above-mentioned structure, as shown in FIGS. 75A-75B, the action of lifting/dropping the engaging portion 11b to open/close the receiving opening 11a in the installation/uninstallation process of the toner cartridge is described in one embodiment. FIG. 75A corresponds to the perspective state of the toner outlet structure inside the housing of the toner cartridge in FIG. 73B, and the toner cartridge may be at the first position at this moment. FIG. 75B corresponds to the perspective state of the toner outlet structure inside the housing of the toner cartridge in FIG. 73C, and the toner cartridge may be at the second position at this moment. For example, when the toner cartridge is at the first position and the toner cartridge is installed on the engaging portion 11b, the engaging portion 11b may enter into the carrying part 554 through the opening 5541 preset in parallel with the axial direction. Before such process, the carrying 554 may be at the first position. At the first position, the carrying surface 5542 of the carrying part 554 may not be in contact with the engaging portion 11b or may only start to contact; and the carrying part 554 may not exert a carrying force on the engaging portion 11b. Meanwhile, the housing 510 may reach above-mentioned preset position for positioning. As the toner cartridge continues to move forward along the installation direction, the toner outlet structure 530 may move relative to the housing 510 along the installation direction, and the first spacing between the housing 510 and the toner outlet structure 530 described above and the first distance G1 between the housing 510 and the ring gear 523 may start to shorten. At the toner outlet structure inside the housing, the distance between the fixing part 551 on the connecting part 560 of the toner outlet structure and the limiting part 552 on the inner wall of the housing may increase from G3 to G4, which is the process from FIG. 75A to FIG. 75B, where G4-G3=G2−G1=Gn. Since two ends of the connecting part 553 are respectively fixed on the fixing part 551 and the carrying part 554, the length of the connecting part 553 cannot be changed. When the fixing part 551 moves with the toner outlet structure 530 along the installation direction of +M to make the distance between the fixing part 551 and the limiting part 552 larger, it may inevitably cause the first end 553a of the connecting part 553 to move along the direction of +M with the fixing part 551 and cause the second end 553b to drive the carrying part 554 to carry the engaging portion 11b to move upward along the direction vertical to the rotation axis L. Subsequently, the carrying surface 5542 of the carrying part 554 may be in contact with the engaging portion 11b, and under the action of the contact, the carrying part 554 may lift the engaging portion 11b to gradually open the receiving opening 11a. By designing the movement distance of the toner cartridge to match the length of the connecting part, when the toner cartridge is fully installed, that is, when the toner cartridge is at the second position, the receiving opening 11a may be fully opened, and the discharge channel of the toner cartridge may be fully opened (same manner as above-mentioned embodiments). At this point, the carrying part 554 may move to the second position closer to the rotation axis L than the first position.

Furthermore, the connecting part may be configured to have a certain amount of elastic force, so that the connecting part may have a stretching amount. On the basis of not affecting the lifting of the engaging portion 11b, optionally, the engaging portion 11b may reach the lifting terminal position (the second position of the carrying part) to preferentially open the receiving opening 11a. At this point, as the toner outlet structure moves further along the +M direction, the connecting part may start to stretch elastically again to adapt to further increase of the distance between the fixing part 551 and the limiting part 552. At such stage, the discharge channel on the toner outlet structure at the bottom of the toner cartridge may be allowed to be fully opened, thereby avoiding toner leakage due to premature discharge of toner from the discharge channel.

It should be understood that the uninstallation process of the toner cartridge from the electronic image-forming apparatus is opposite to above-mentioned installation process; the engaging portion 11b may be dropped and the receiving opening 11a may be closed, which may not be further described herein.

Furthermore, a locking part may also be disposed on the toner cartridge. The locking part may be at the second position of the carrying part. For example, the locking part may be a retractable locking surface. When the engaging portion of the carrying moves upward to the end position (the second position of the carrying part), the locking surface may retract automatically with upward rising interference force of the engaging portion or the carrying part, and then automatically protrude out with the elastic recovery force when the interference is released, such that the engaging portion may be further supported on the locking surface without falling. The engaging portion may be locked at the second position by the locking part. When the toner cartridge is uninstalled, the toner cartridge may carry the locking part on the toner cartridge to move along the opposite direction together, such that the engaging portion may separate from the locking surface of the locking part along the axial direction to release the lock, and the engaging portion may further move downward with the carrying part.

### Exemplary Embodiment Seventeen

Exemplary embodiment seventeen is an improvement on the basis of exemplary embodiment fifteen. A new toner outlet structure is provided in one embodiment. In one embodiment, the guiding portion of the toner outlet structure may not be disposed, and the receiving opening of the developer replenishment apparatus may be no longer opened through the guiding portion.

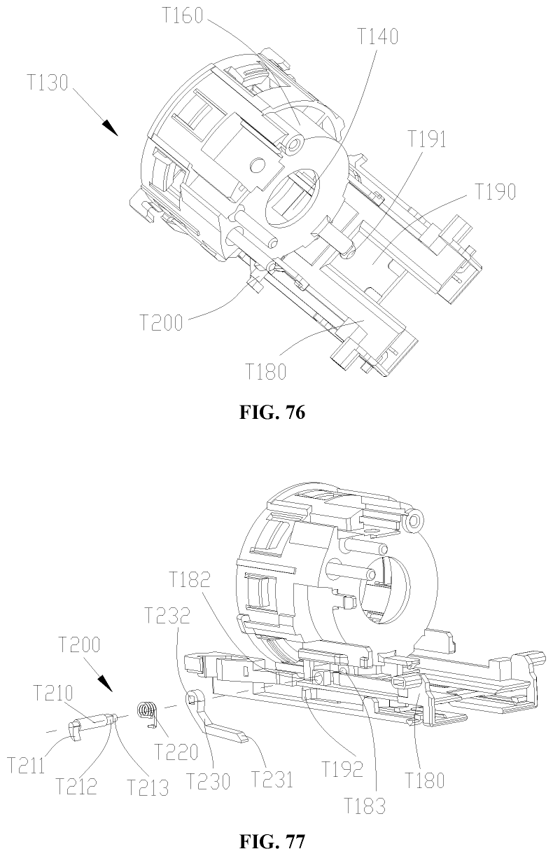

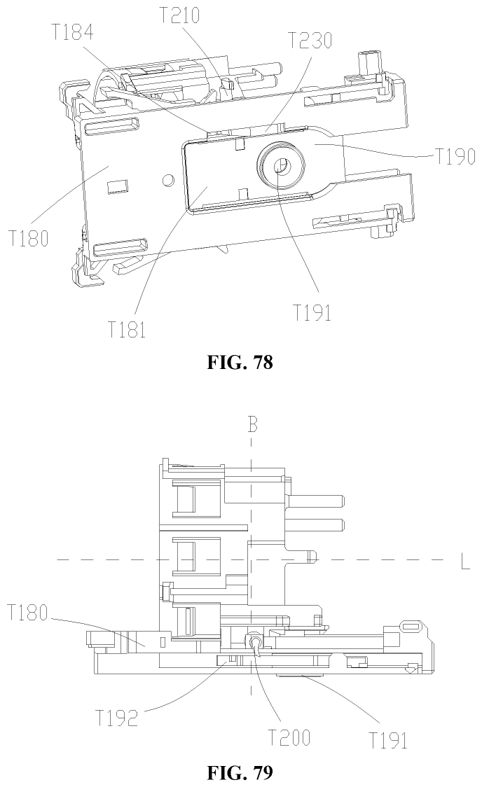

As shown in FIGS. 76-78, a toner outlet structure T130 may include a connecting part T160, a fixed toner outlet plate T180 and a movable toner outlet plate T190. For example, the connecting part T160 may be disposed with a toner outlet opening T140; the fixed toner outlet plate T180 may be connected to the connecting part T160; the fixed toner outlet plate T180 may include an opening T181 located at the bottom of the fixed toner outlet plate T180; and the size of the opening T181 may be larger than the size of the toner outlet T140. Furthermore, the movable toner outlet plate T190 may be disposed between the connecting part T160 and the fixed toner outlet plate T180, where a toner outlet hole T191 may be disposed on the movable toner outlet plate T190.

The toner outlet structure T130 may also include a control mechanism T200. Optionally, the control mechanism T200 may be disposed on the sidewall of the fixed toner discharge plate T180 and configured to act on the blocking piece 15 for sealing the receiving opening 11a in the developer replenishing apparatus 8 during the installation of the toner cartridge (as shown in FIG. 2B), such that the receiving opening 11a may be opened to form the developer discharge channel. In one embodiment, it only shows the control mechanism T200 located on one side of the fixed toner outlet plate T180. Optionally, in order to strengthen the opening strength of the blocking piece 15, the control mechanism T200 may be disposed on each of two sidewalls of the fixed toner outlet plate T180.

For example, the control mechanism T200 may include a force-receiving part T210, a fourth elastic part T220 and a pushing part T230. Furthermore, one end of the force-receiving part T210 may be disposed with a force-receiving portion T211, and the other end of the force-receiving part T210 may be disposed with a cylindrical axle supporting portion T213, where the force-receiving part may further include a square fixing portion T212 adjacent to the axle supporting portion T213 for supporting the pushing part T230. Optionally, in order to better receive external force, the force-receiving portion T211 may be also disposed with a crescent-shaped inclined surface. One end of the pushing part T230 may be disposed with an axle hole T232 matching the shape of the fixing portion T212, and the other end of the pushing part T230 may include an inclined surface T231.

When the control mechanism T200 is assembled on the toner outlet structure T130, the force-receiving part T210 may first pass through the first through hole T182 on the sidewall of the fixed toner outlet plate T180. At this point, a part of the force-receiving part T210 may be located in a notch T184 between the first through hole T182 and the second through hole T183 on the sidewall of the fixed toner outlet plate T180. Next, one end of the fourth elastic part T220 passing through the axle supporting portion T213 may be sleeved on the force-receiving part T210. Secondly, by fixing the fixing part T212 with the axle hole T232, the pushing part T230 may be fixed on the force-receiving part T210, such that the force-receiving part T210 may rotate together with the pushing part T230 when being rotated by an external force; and the pushing part T230 may be also exposed to the outside of the fixed toner outlet plate T180 through the notch T184. Finally, the fixing part T213 may be installed in the second through hole T183, such that entire control mechanism T200 may be fixedly installed on the toner outlet structure T130. The fourth elastic part T220 may be a torsion spring, one end of the fourth elastic part T220 may be abutted against the pushing part T230, and the other end of the fourth elastic part T220 may be abutted against the first through hole T182, which ensures that the force-receiving part T210 can make the control mechanism T200 return to original state after no external force is applied.

In one embodiment, in order to improve the sealing performance when the developer discharge channel is formed between the toner outlet structure of the toner cartridge and the developer replenishment apparatus, the height of the toner outlet hole T191 of the movable toner outlet plate T190 may increase along the direction away from the rotation axis L of the toner cartridge; and viewed from the direction perpendicular to the rotation axis L, the toner outlet hole T191 may be exposed to the outside of the fixed toner outlet plate T180 through the opening T181 (that is, the toner outlet hole T191 protrudes from the bottom of the fixed toner outlet plate T180). Therefore, it ensures that the toner outlet hole T191 and the receiving opening 11a of the developer replenishment apparatus can be tightly fitted after the toner cartridge is installed in place, thereby preventing the developer from scattering when the developer in the toner cartridge is transferred to the developer replenishment apparatus.

As shown in FIG. 79, when the toner cartridge is not installed in the developer replenishment apparatus of the electronic image-forming apparatus, the toner outlet hole T191 of the movable toner outlet plate T190 may have not yet coincided with the central axis B of the toner outlet T140; the control mechanism T200 may be not affected by external force, and the control mechanism T200 may be at the initial position at this moment.

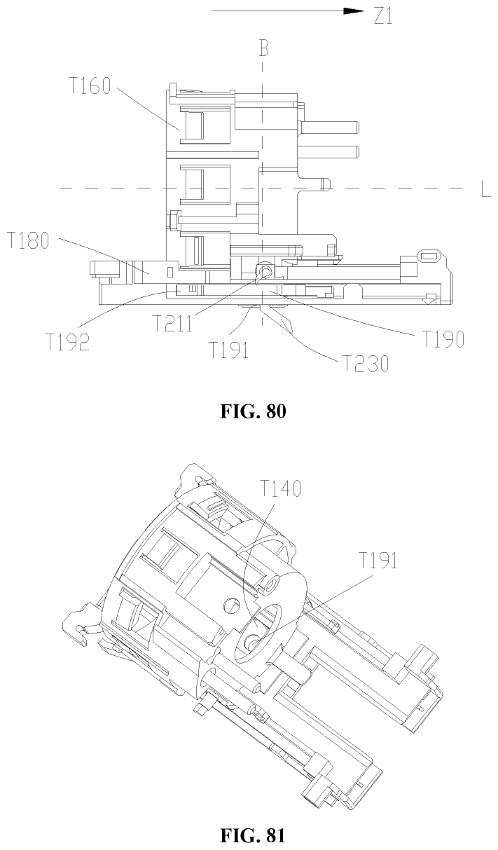

As shown in FIGS. 80-81, when the toner cartridge is installed in the developer replenishing apparatus of the electronic image-forming apparatus, the abutting parts T192 on two sides of the movable toner outlet plate T190 may be respectively locked with the first sliding-plate locking portion 8a and the second sliding-plate locking portion 8a (as shown in FIG. 2A), such that the movable toner outlet plate T190 may be engaged with the developer replenishing apparatus 8 to maintain a fixed state. The fixed toner outlet plate T180 may continue to be installed along with the toner outlet structure T130 along the installation direction (the Z1 direction in FIG. 80), such that the movable toner outlet plate T190 and the fixed toner outlet plate T180 may move relatively. At this point, the control mechanism T200 installed on the fixed toner outlet plate T180 may also move to the position being abutted against the limiting portion (not shown in FIG. 2A) located on the front side of the developer receiving portion 11. As the toner cartridge continues to be installed, the force-receiving portion T211 of the force-receiving portion T210 may be applied by a force opposite to the direction of Z1 by the limiting part to rotate clockwise around the axis of the first through hole T182 (clockwise rotation observed from the perspective of FIGS. 79 and 80). Since the pushing part T230 is connected to the force-receiving part T210, the force-receiving part T210 may also drive the pushing part T230 to rotate clockwise while rotating, and the inclined surface T231 of the pushing part T230 may move to the position that the inclined surface T231 contacts and interferes with the blocking piece 15. In addition, along with the movement of the toner cartridge, the pushing part T230 may be applied by a force to the blocking piece 15 sealing the receiving opening 11b to open the receiving opening 11a, and the developer receiving portion 11 may move upward to a certain height with the opening of the receiving opening 11a. At this point, the toner outlet hole T191 may move to the position coincident with the central axis B of the toner outlet T140, that is, the projection of the toner outlet T191 along the direction of the central axis B may be completely within the projection of the toner outlet T140 along the direction of the central axis B (as shown in FIG. 81). At this point, the control mechanism T200 may be at the second position. The toner outlet hole T191 may be successfully matched and engaged with the receiving opening 11a to form the developer discharge channel. Finally, the developer in the toner cartridge may flow into the developer replenishing apparatus smoothly through the toner outlet T140, the toner outlet T191 and the opening T181 in sequence.

### Exemplary Embodiment Eighteen

Exemplary embodiment eighteen is a further improvement on exemplary embodiment seventeen. A new toner outlet structure, which also includes a toner outlet part, is provided.

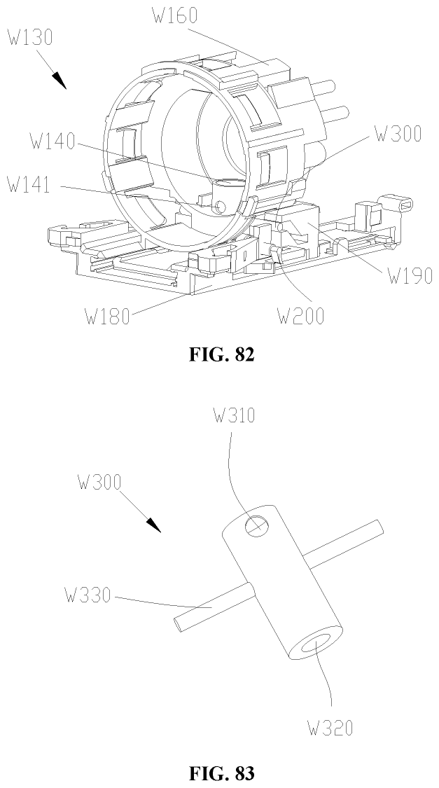

As shown in FIGS. 82-86, a toner outlet structure W130 may include a connecting portion W160, a fixed toner outlet plate W180 and a movable toner outlet plate W190. For example, the connecting portion W160 may be disposed with a toner outlet portion W140; the toner outlet portion W140 may be a hollow cylindrical structure; a through hole W141 may be formed on the side of the toner outlet portion W140; and a toner outlet opening may be formed at the bottom of the toner outlet portion W140. The fixed toner outlet plate W180 may be connected to the connecting portion W160, and the fixed toner outlet plate W180 may include an opening W181 at the bottom of the fixed toner outlet plate W180, and the size of the opening W181 may be larger than the size of the toner outlet opening. Furthermore, the movable toner outlet plate W190 may be disposed between the connecting portion W160 and the fixed toner outlet plate W180, where a toner outlet hole W191 may be formed on the movable toner outlet plate W190.

As shown in FIG. 83, the toner outlet structure may include a toner outlet part W300 which is movably installed in the toner outlet portion W140 and capable of moving up and down relative to the toner outlet portion W140. For example, one end of the toner outlet part W300 may be sealed, and a lower toner hole W320 may be formed at the other end of the toner outlet part W300. In addition, a docking opening W310 may be at the side adjacent to the sealed end, and supported parts W330 may be oppositely disposed on two sides of the toner outlet part W300.

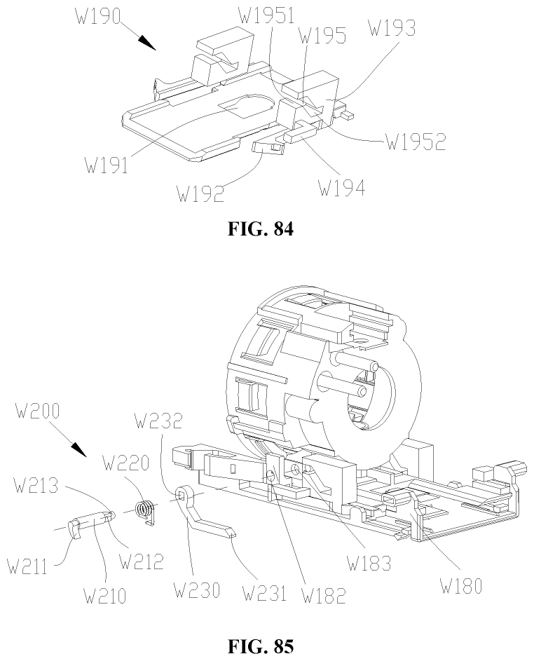

As shown in FIG. 84, compared with the movable toner outlet plate W190 in exemplary embodiment seventeen, the movable toner outlet plate W190 in one embodiment may be further disposed with a supporting block W193. For example, the supporting blocks W193 may be respectively disposed on two sides of the movable toner outlet plate W190, and the supporting block W193 may include a sliding groove W195. The sliding groove 195 may be disposed with a first stepped surface W1951 and a second stepped surface W1952. A height difference (displacement difference) may be between the first stepped surface W1951 and the second stepped surface W1952; and the first stepped surface W1951 may be closer to the rotation axis L of the toner cartridge than the second stepped surface W1952. In addition, the supporting block W193 may be further disposed with a protrusion W194 extending outward.

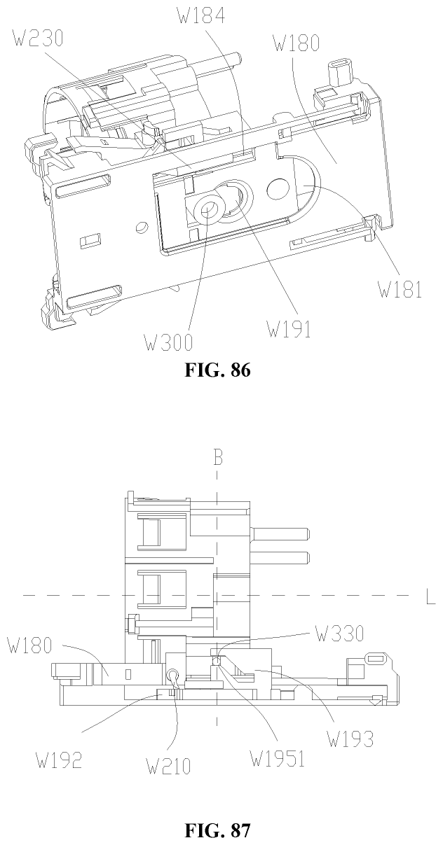

As shown in FIGS. 85-86, a control mechanism W200 with a same structure in exemplary embodiment seventeen is provided in one embodiment. The control mechanism W200 may include a force-receiving part W210, a fourth elastic part W220 and a pushing part W230. Furthermore, one end of the force-receiving part W210 may be disposed with a force-receiving portion W211, and the other end of the force-receiving part W210 may be disposed with a cylindrical axle supporting portion W213. The force-receiving part W210 may further include a squared fixing portion W212 adjacent to the axle supporting portion W213 for supporting the pushing part W230. Optionally, in order to better receive external force, the force-receiving portion W211 may be also disposed with a crescent-shaped inclined surface. One end of the pushing part W230 may be disposed with an axle hole W232 matching the shape of the fixing portion W212, and the other end of the pushing part W230 may include an inclined surface W231. Since the structure of the control mechanism W200 is same as the structure of the control mechanism in exemplary embodiment seventeen, the process of assembling the control mechanism W200 to the toner outlet structure W130 is not described in detail herein.

The connection relationship between the toner outlet part W300 and the movable toner outlet plate W190 is described hereinafter.

The toner outlet part W300 may be movably connected with the connecting portion W160 by being installed in the toner outlet part W140. For example, the sealed end of the toner outlet part W300 may be located inside the connecting portion W160, and the end with the lower toner hole W320 may be exposed to the bottom of the movable toner outlet plate W190 through the toner outlet hole W191. Furthermore, the supported part W330 may be placed on the first stepped surface W1951 of the sliding groove W195, such that the toner outlet part W300 and the movable toner outlet plate W190 may be movably connected to each other.

As shown in FIGS. 82 and 87, when the toner cartridge is not installed in the developer replenishment apparatus of the electronic image-forming apparatus, the toner outlet part W300 may be in the state of sealing the toner outlet portion W140, the docking opening W310 may not match/align with the through hole W141, and the supported part W330 of the toner outlet part W300 may be located at the first stepped surface W1951 of the supporting block 195. At this point, the control mechanism T200 may be at the initial position.

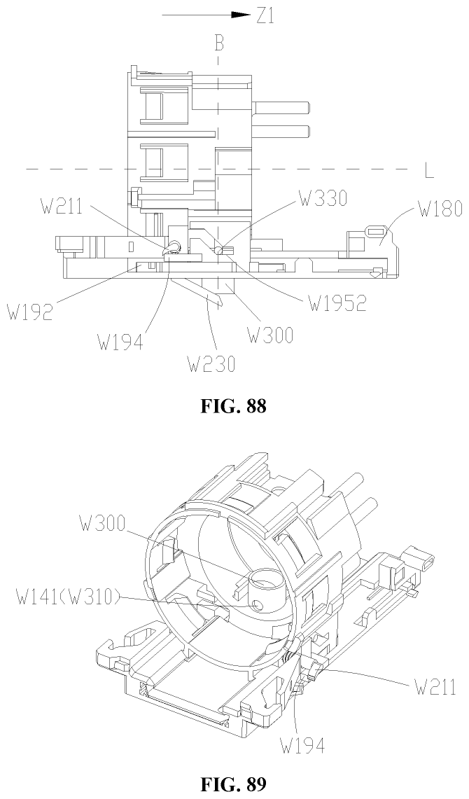

As shown in FIGS. 88 and 89, when the toner cartridge is installed in the developer replenishing apparatus of the electronic image-forming apparatus, the abutting parts W192 on two sides of the movable toner outlet plate W190 may be respectively locked with the first sliding-plate locking portion 8a and the second sliding-plate locking portion 8a (as shown in FIG. 2A), such that the movable toner outlet plate W190 may be engaged with the developer replenishing apparatus 8 to maintain a fixed state. The fixed toner outlet plate W180 may continue to be installed with the toner outlet structure W130 along the installation direction (the Z1 direction in FIG. 88), such that the movable toner outlet plate W190 and the fixed toner outlet plate W180 may move relatively. At this point, the supported part W330 supported on the first stepped surface W1951 may also move in the sliding groove W195 along the Z1 direction and cause the toner outlet part W300 to sink in the toner outlet part W140 (that is, move along a linear light in the direction away from the axis L); and the force-receiving portion W210 of the control mechanism W200 installed on the fixed toner outlet plate W180 may also move to the position being abutted against the protrusion W194 of the movable toner outlet plate W190. As the toner cartridge continues to be installed, the force-receiving portion W211 of the force-receiving part W210 may be subjected to a force opposite to the Z1 direction given by the protrusion W194 and rotate clockwise around the axis of the first through hole W182 (observed from the perspective of FIG. 87 and FIG. 88). Since the pushing part W230 is connected with the force-receiving piece W210, the force-receiving piece W210 may also drive the pushing part W230 to rotate clockwise while rotating. The inclined surface W231 of the pushing part W230 may move to the position that the inclined surface W231 contacts and interferes with the blocking piece 15. In addition, along with the movement of the toner cartridge, the pushing part W230 may apply a force to the blocking piece 15 for sealing the receiving opening 11b to open the receiving opening 11a, and the developer receiving portion 11 may move upward to a certain height with the opening of the receiving opening 11a. During such process, the supported part W330 of the toner outlet part W300 may also move from the position of the first stepped surface W1951 to the position of the second stepped surface W1952, that is, the toner outlet part W300 may move down in the toner outlet portion W140 to the position that the through hole W141 is coincided with the docking opening W310. At this point, the toner outlet part W300 and the toner outlet part W141 may be in a state of communication, the control mechanism W200 may be at the second position, and the toner cartridge and the developer replenishing apparatus may form the developer discharge channel. Therefore, the developer in the toner cartridge can be delivered to the developer replenishing apparatus sequentially through the through hole W141, the docking opening W310, the lower toner hole W320, the toner outlet hole W191 and the opening W181.

### Exemplary Embodiment Nineteen

Exemplary embodiment nineteen is a further improvement in combination with exemplary embodiment seventeen and embodiment eighteen. A new control mechanism with a more simplified and efficient structure is provided.

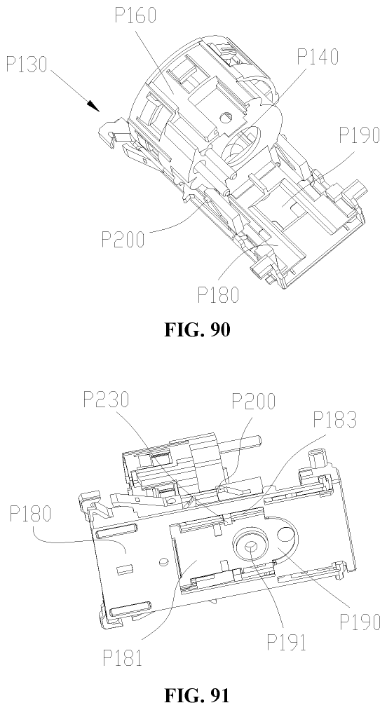

As shown in FIGS. 90-92, a toner outlet structure P130 may include a connecting portion P160, a fixed toner outlet plate P180 and a movable toner outlet plate P190. For example, the connecting portion P160 may be disposed with a toner outlet opening P140, and the fixed toner outlet plate P180 may be connected to the connecting portion P160; and the fixed toner outlet plate P180 may include an opening P181 disposed at the bottom of the fixed toner outlet plate P180, and the size of the opening P181 may be larger than the size of the toner outlet P140. Furthermore, the movable toner outlet plate P190 may be disposed between the connecting portion P160 and the fixed toner outlet plate P180, where a toner outlet hole P191 may be disposed on the movable toner outlet plate P190.

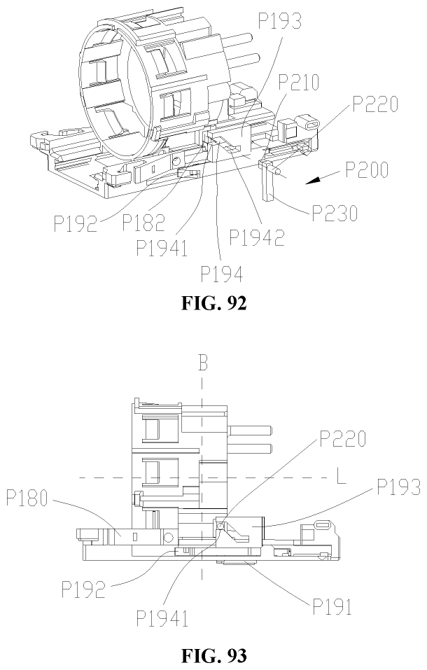

As shown in FIG. 92, compared with the movable toner outlet plate in exemplary embodiment seventeen, the movable toner outlet plate P190 in one embodiment may be disposed with more supporting blocks P193. For example, the supporting blocks P193 may be respectively arranged on two sides of the movable toner outlet plate P190. The supporting block P193 may include a sliding groove P194. The sliding groove P194 may be disposed with a first stepped surface P1941 and a second stepped surface P1942; and a height difference may be between the first stepped surface P1941 and the second stepped surface P1942.

The toner outlet structure P130 may also include a control mechanism P200, which is configured to act on the blocking piece 15 (as shown in FIG. 2B) that seals the receiving opening 11a in the developer replenishing apparatus 8 during the installation of the toner cartridge, such that the receiving opening 11a may be opened to form the developer discharge channel. Optionally, in order to enhance the strength of opening the blocking piece 15, in one embodiment, the control mechanism P200 may be respectively disposed on each of two sides of the fixed toner outlet plate P180.

For example, the control mechanism P200 may include a first supporting portion P210, a second supporting portion P220 and a pushing portion P230. The first supporting portion P210 and the second supporting portion P220 may be oppositely disposed on two sides of the pushing part P230, and the pushing part P230 may be a straight rob structure. Furthermore, the first supporting portion P210 may be installed in a groove P182 of the fixed toner outlet plate P180 and may slide up and down in the groove P182. The second supporting portion P220 may be abutted against the first stepped surface P1941 of the supporting block P193; and the pushing part P230 may be exposed outside the fixed toner outlet plate P180 through the groove P183, such that the control mechanism P200 may be movably connected with the fixed toner outlet plate P180.

In one embodiment, in order to improve sealing performance when the developer discharge channel is formed between the toner outlet structure of the toner cartridge and the developer replenishment apparatus, the height of the toner outlet hole P191 of the movable toner outlet plate P190 may increase along the direction away from the rotation axis L of the toner cartridge; and viewed from the direction perpendicular to the rotation axis L, the toner outlet hole P191 may be exposed outside the fixed toner outlet plate P180 through the opening P181. Therefore, it ensures that the toner outlet hole P191 and the receiving opening 11a of the developer replenishment apparatus may closely fit after the toner cartridge is installed in place, thereby preventing the developer from scattering when the developer in the toner cartridge is transferred to the developer replenishment apparatus.

As shown in FIG. 93, when the toner cartridge is not installed in the developer replenishment apparatus of the electronic image-forming apparatus, the toner outlet hole P191 of the movable toner outlet plate P190 may have not yet coincided with the central axis B of the toner outlet P140; and the second supporting portion P220 of the control mechanism P200 may be located at the first stepped surface P1941 of the supporting block P194. At this moment, the control mechanism P200 may be at the initial position.

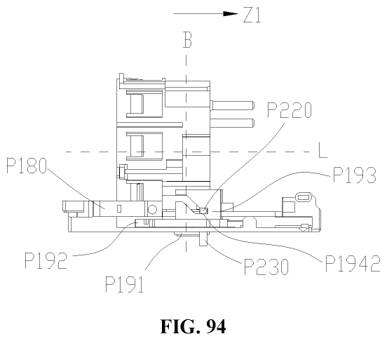

As shown in FIG. 94, when the toner cartridge is installed to the developer replenishing apparatus of the electronic image-forming apparatus, the abutting parts P192 on two sides of the movable toner outlet plate P190 may be respectively locked with the first sliding-plate locking portion 8a and the second sliding-plate locking portion 8a (as shown in FIG. 2A), such that the movable toner outlet plate P190 may be engaged with the developer replenishing apparatus 8 to maintain a fixed state. The fixed toner outlet plate P180 may continue to be installed along with the toner outlet structure P130 along the installation direction (the Z1 direction in FIG. 80), such that the movable toner outlet plate P190 and the fixed toner outlet plate P180 may move relatively. At this point, the second supporting portion P220 abutting against the first stepped surface P1941 of the supporting block P193 may move to the second stepped surface P1942 along the slide groove P194; and the first supporting portion P210 of the control mechanism P200 may also move downward in the groove P182 along the direction away from the rotation axis L, and the pushing part P230 may move down to the position that the pushing part P230 is abutted against the blocking piece 15. The blocking piece 15 may be formed by two movable sealing parts (not shown in drawings), two movable sealing part may rotate around the rotation axle to open the receiving opening 11a and drive the receiving opening 11a to move upward. Therefore, when the pushing part P230 moves down to the gap between two movable sealing parts of the blocking piece 15 and is abutted against one of the movable sealing parts, with the installation of the toner cartridge, the pushing part P230 may apply the movable sealing parts a force along the Z1 direction, such that the movable sealing parts may be forced to rotate to open the receiving opening 11a and drive the receiving opening 11a to move upward. During such process, the second supported part P220 of the control mechanism P200 may also move from the position of the first stepped surface P1941 to the position of the second stepped surface P1942, that is, the toner outlet hole P191 may move to the position which is coincident with the central axis B of the toner outlet P140. At this point, the control mechanism P200 may be at the second position, the toner outlet hole P191 may be successfully docked with the receiving opening 11a, and the toner cartridge and the developer replenishing apparatus may form the developer discharge channel.

From above-mentioned embodiments, it may be seen that the solutions provided in the present disclosure may achieve at least following beneficial effects.

The toner cartridge of the present disclosure provides a new manner to open the receiving opening. By disposing the control mechanism on the toner outlet mechanism to act on the developer receiving portion or the blocking piece to open the receiving opening when the toner cartridge is installed, the receiving opening does not be abutted against other parts (such as the fixed toner outlet plate or the movable toner outlet plate) of the toner outlet structure prematurely during the installation process of the toner cartridge, thereby avoiding the scattering of the developer caused by reasons such as friction and vibration of the developer during the installation and movement of the toner cartridge.

Above may be merely optional embodiments of the present disclosure, which may not be intended to limit the present disclosure. Any modifications, equivalent replacements, improvements and the like made within the spirit and principles of the present disclosure shall be included within the protection scope of the present disclosure.

What is claimed is:

1. A toner cartridge, detachably installed in an electronic image-forming apparatus, wherein the electronic image-forming apparatus includes a developer replenishing apparatus; the developer replenishing apparatus includes a developer receiving portion; the developer receiving portion includes a receiving opening; and the receiving opening is disposed with a blocking piece for sealing the receiving opening, the toner cartridge comprising:
a toner cartridge body, configured to store developer; and
a toner outlet structure, wherein the toner outlet structure is connected to a toner outlet end of the toner cartridge body and configured to discharge the developer in the toner cartridge body; the toner outlet structure includes a connecting part, a fixed toner outlet plate and a movable toner outlet plate; the connecting part is connected to the toner cartridge body; a toner outlet opening is formed at the connecting part; the fixed toner outlet plate is connected to a bottom of the connecting part and includes an opening; and the movable toner outlet plate is disposed between the connecting part and the fixed toner outlet plate and includes a toner outlet hole, wherein:
the toner outlet structure further includes a control mechanism, configured to act on the developer receiving portion or the blocking piece during an installation process of the toner cartridge to cause relative motion between the control mechanism and one of the developer receiving portion and the blocking piece, thereby opening the receiving opening.

2. The toner cartridge according to claim 1, wherein:
the movable toner outlet plate is disposed with a supporting block; the supporting block includes a sliding groove; the sliding groove includes a first stepped surface and a second stepped surface; and a height difference is between the first stepped surface and the second stepped surface.

3. The toner cartridge according to claim 2, wherein:
the connecting part is disposed with a toner outlet portion; an inside of the toner outlet portion is hollow; the toner outlet opening is formed at a bottom of the toner outlet portion; and a through hole is formed at a sidewall of the toner outlet portion.

4. The toner cartridge according to claim 3, wherein:
the toner outlet structure further includes a toner outlet part; the toner outlet part is movably disposed in the toner outlet portion and capable of moving up and down in the toner outlet portion; a top of the toner outlet part is sealed, a lower toner hole is formed at a bottom of the toner outlet part, a docking opening is formed at a sidewall of the toner outlet part; and the docking opening and the lower toner hole are communicated with each other inside the toner outlet part.

5. The toner cartridge according to claim 4, wherein:
an outer side of the toner outlet part is disposed with a supported part; and the supported part is disposed in the sliding groove and capable of moving in the sliding groove; and
when the supported part slides from the first stepped surface to the second stepped surface of the sliding groove, the toner outlet part moves to the docking opening in the toner outlet portion to be communicated with the through hole.

6. The toner cartridge according to claim 1, wherein:
a height of the toner outlet hole increases along a direction away from a rotation axis of the toner cartridge; and viewed from a direction perpendicular to the rotation axis of the toner cartridge, the toner outlet hole is exposed to an outside of the fixed toner outlet plate through the opening.

7. The toner cartridge according to claim 2, wherein:
the control mechanism includes a force-receiving part and a pushing part; the force-receiving part and the pushing part are rotatably disposed on the fixed toner outlet plate; and the force-receiving part is capable of driving the pushing part to rotate synchronously when the force-receiving part is rotated by an external force.

8. The toner cartridge according to claim 7, wherein:
the supporting block is further disposed with a protrusion protruding and extending outward; and during the installation process of the toner cartridge, the protrusion is in contact with the force-receiving part and pushes the force-receiving part to rotate, the pushing part is driven by the force-receiving part to rotate to a position in contact with the blocking piece and pushes the blocking piece to move relative to the developer receiving portion, thereby opening the receiving opening.

9. The toner cartridge according to claim 7, wherein:
the control mechanism further includes a fourth elastic part; and one end of the fourth elastic part is abutted against the force-receiving part, and another end of the fourth elastic part is abutted against the pushing part, which is configured to maintain the control mechanism at an initial position without an external force.

10. The toner cartridge according to claim 2, wherein:
the control mechanism includes a first supporting portion, a second supporting portion and a pushing portion; the first supporting portion and the second supporting portion are oppositely disposed on two sides of the pushing portion; the first supporting portion is installed in a groove of the fixed toner outlet plate and capable of moving up and down in the groove; the second supporting portion is disposed in the sliding groove and capable of moving in the sliding groove; and a part of the pushing portion is exposed to an outside the fixed toner outlet plate.

11. The toner cartridge according to claim 10, wherein:
the pushing portion is a straight rod structure.

12. The toner cartridge according to claim 10, wherein:
during the installation process of the toner cartridge, the first support portion moves downward in the groove; the second supporting portion moves from the first stepped surface to the second stepped surface of the sliding groove; and the pushing portion moves downward to a position in contact with the blocking piece and pushes the blocking piece to move relative to the developer receiving portion, thereby opening the receiving opening.

13. The toner cartridge according to claim 1, wherein:
the toner outlet structure includes a guiding portion; the guiding portion includes a first end portion and a second end portion; and the second end portion is closer to a rotation axis of the toner cartridge than the first end portion.

14. The toner cartridge according to claim 13, wherein:
the control mechanism includes a pushing part and a connecting part; an axle hole is formed at one end of the pushing part, and an inclined surface is formed at another end of the pushing part; and the connecting part passes through the axle hole to connect the pushing part to the fixed toner outlet plate.

15. The toner cartridge according to claim 14, wherein:
during the installation process of the toner cartridge, when an engaging portion of the developer receiving portion climbs from the first end portion to the second end portion of the guiding portion, the pushing part is at a position of forming contact and interference with the developer receiving portion, the inclined surface of the pushing part is abutted against a base of the developer receiving portion and rotates around the connecting part under a force of the base, thereby driving the developer receiving portion to move upward.

16. The toner cartridge according to claim 14, wherein:
the control mechanism further includes a movable part and a first elastic part; the movable part is disposed with a connecting hole and a bent supporting portion; the connecting part sequentially passes through the axle hole and the connecting hole to movably connect the pushing part and the movable part; and the first elastic part is disposed between the supporting portion and the connecting part.

17. The toner cartridge according to claim 16, wherein:
the pushing part and the connecting part are capable of moving up and down relative to the movable part; and when the connecting part moves up and down, the first elastic part elastically deforms.

18. The toner cartridge according to claim 17, wherein:
the control mechanism further includes a second elastic part; and the second elastic part is connected between the movable part and the fixed toner outlet plate and configured to limit movement of the control mechanism along the rotation axis of the toner cartridge.
